(19) United States
(12) Patent Application Publication
(10) Pub. No.: US 2018/0253717 A1
(43) Pub. Date: Sep. 6, 2018

(54) TERMINAL APPARATUS AND CONTROL METHOD FOR TERMINAL APPARATUS

(71) Applicant: LG ELECTRONICS INC., Seoul (KR)

(72) Inventors: Boram KIM, Seoul (KR); Dongsu HAN, Seoul (KR); Hyewon SONG, Seoul (KR); Mihyun PARK, Soeul (KR)

(73) Assignee: LG ELECTRONICS INC., Seoul (KR)

(21) Appl. No.: 15/758,657

(22) PCT Filed: Sep. 25, 2015
(86) PCT No.: PCT/KR2015/010197

§ 371 Date: Mar. 8, 2018

(51) Int. Cl. G06Q 20/32; G06Q 20/40; G06F 3/0488; G06F 3/01

(52) U.S. Cl. CPC G06Q 20/3223; G06Q 20/3227; G06F 3/016; G06F 3/04883; G06Q 20/40145

(57) ABSTRACT

A terminal apparatus and a control method are provided. The terminal apparatus includes a sensing unit for sensing a predetermined input signal; a display unit for displaying a content and receiving an input of a touch gesture; and a control unit for activating a general payment mode when the predetermined input signal is not sensed and an input of a payment application execution command is received, and activating a secret payment mode when the predetermined input signal is sensed.

### TECHNICAL FIELD

The present invention relates to a terminal apparatus and a control method for the terminal apparatus.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As such functions become more diversified, the terminal can support more complicated functions such as capturing images or video, reproducing music or video files, playing games, receiving broadcast signals, and the like. By comprehensively and collectively implementing such functions, the mobile terminal may be embodied in the form of a multimedia player.

In order to support and increase the functions of the terminal, it may be considered to improve a structural part and/or software part of the terminal.

Recently, the terminal includes a payment function. Therefore, the need of the technology capable of using a payment function conveniently and managing payment details has been increased.

### DISCLOSURE

### Technical Problem

An object of the present invention has been devised to solve the aforementioned problems of the related art and the other problems. Another object of the present invention is to provide a terminal apparatus and a control method for the same, in which a payment function may be performed in various modes.

The technical objects that can be achieved through the present invention are not limited to what has been particularly described hereinabove and other technical objects not described herein will be more clearly understood by persons skilled in the art from the following detailed description.

### Technical Solution

To achieve the above objects and other objects, according to one aspect of the present invention, a terminal apparatus (or device) comprises a sensing unit for sensing a preset input signal; a display unit for displaying a content and receiving an input of a touch gesture; and a controller activating a normal payment mode when the preset input signal is not sensed and an execution command of a payment application is input, and activating a private payment mode when the preset input signal is sensed.

The preset input signal may include at least one of a vibration gesture input signal related to vibration of the terminal apparatus, a fingerprint input signal, and a touch input signal for a preset area.

Meanwhile, the controller may control the display unit to display a glance view area indicating the private payment mode if a swipe gesture moving to a first direction on the preset area of the display unit is input after the private payment mode is activated.

The controller may allow the glance view area to disappear if the touch of the swipe gesture ends.

Also, the controller may maintain the glance view area if the touch of the swipe gesture ends after the swipe gesture is switched to a second direction which is previously set.

Also, the controller may control the display unit to display at least one card on the glance view area if the private payment mode corresponds to a payment step.

The controller may control the display unit to display at least one authentication system on the glance view area if the private payment mode corresponds to an authentication step.

At least one authentication system may include at least one of a fingerprint authentication system, a color pattern authentication system, a password authentication system, and a signature authentication system.

The terminal apparatus may further comprise an output unit for outputting a signal whenever the private payment mode is changed after the private payment mode is activated.

The output unit may include at least one of an LED and a vibration motor.

Also, the controller may control the display unit to display a preset card if a swipe gesture moving from a center area of a lower corner of the display unit to a third direction is input after the normal payment mode or the private payment mode ends.

Also, if a gesture for enlarging a screen is input after the card is displayed, the controller may control the display unit to display a receipt storage screen related to the card.

The controller controls the display unit to display paid details if a swipe gesture moving from both side areas of a lower corner of the display unit to a third direction is input after the normal payment mode or the private payment mode ends.

Also, the sensing unit may sense a grip state of a user, and the controller may control the display unit to display the paid details on the basis of the swipe gesture moving from a left area of the lower corner of the display unit to the third direction if it is determined that the user grips the terminal apparatus with a left hand, and may control the display unit to display the paid details on the basis of the swipe gesture moving from a right area of the lower corner of the display unit to the third direction if it is determined that the user grips the terminal apparatus with a right hand.

Also, the controller may control the display unit to display a receipt temporary storage screen if a 2-finger swipe gesture moving from a first preset side corner of the display unit to an opposite side corner is input after the normal payment mode or the private payment mode ends.

The controller may control the display unit to display a receipt storage screen if a 2-finger swipe gesture moving from a second preset side corner of the display unit to an opposite side corner is input after the normal payment mode or the private payment mode ends.

Also, if a touch input signal for the preset area is input, the controller may control the display unit to display a color figure indicating a first step as a first background color within a preset range from the touched point.

Also, the controller may control the display unit to display a selection menu if a swipe gesture moving from the color figure to a first direction is input.

If a touch gesture for the color figure is input, the controller may control the display unit to end a current step and switch to a color figure indicating a second step as a second background color.

According to another aspect of the present invention, a control method for a terminal apparatus comprises the steps of sensing whether a preset input signal is input; and activating a normal payment mode when the preset input signal is not sensed and an execution command of a payment application is input, and activating a private payment mode when the preset input signal is sensed.

### Advantageous Effects

Advantageous effects of a mobile terminal apparatus and a control method therefor according to the present specification are as follows.

According to at least one of various embodiments of the present invention, it is advantageous that a payment function may be performed in various modes.

According to at least one of the embodiments of the present invention, it is advantageous that it is possible to perform a payment function conveniently while maintaining security.

Also, according to at least one of the embodiments of the present invention, it is advantageous that it is possible to manage a receipt conveniently.

### BRIEF DESCRIPTION OF THE DRAWINGS

FIG. 1a is a diagram illustrating a mobile terminal according to the present invention.

FIGS. 1b and 1c are conceptual views of one example of a mobile terminal according to the present invention, viewed from different directions.

FIG. 2 is a block diagram illustrating a terminal apparatus according to one embodiment of the present invention.

FIG. 3 is a view illustrating a terminal apparatus, which performs a private payment, according to one embodiment of the present invention.

FIG. 4 is a view illustrating an example that a private payment function is activated.

FIG. 5 is a view illustrating an example that a glance view area is displayed.

FIG. 6 is a view illustrating an example that a payment step is notified from a private payment mode.

FIG. 7 is a view illustrating another example that a payment step is notified from a private payment mode.

FIG. 8 is a view illustrating an example that a card is changed.

FIG. 9 is a view illustrating an example that all cards are displayed.

FIG. 10 is a view illustrating a method for checking a payment amount in accordance with one embodiment of the present invention.

FIG. 11 is a view illustrating a method for selecting an installment payment according to one embodiment of the present invention.

FIG. 12 is a view illustrating a fingerprint authentication system according to one embodiment of the present invention.

FIG. 13 is a view illustrating a color pattern authentication system according to one embodiment of the present invention.

FIG. 14 is a view illustrating a password authentication system according to one embodiment of the present invention.

FIG. 15 is a view illustrating a signature authentication system according to one embodiment of the present invention.

FIG. 16 is a view illustrating a method for selecting an authentication system according to one embodiment of the present invention.

FIG. 17 is a view illustrating a terminal apparatus, in which a color pattern authentication system is selected, according to one embodiment of the present invention.

FIG. 18 is a view illustrating a terminal apparatus, in which a password authentication system is selected, according to one embodiment of the present invention.

FIG. 19 is a view illustrating a terminal apparatus, in which a signature authentication system is selected, according to one embodiment of the present invention.

FIG. 20 is a view illustrating a method for switching to a previous step in accordance with one embodiment of the present invention.

FIG. 21 is a view illustrating an example that a payment which is interrupted is completed.

FIG. 22 is a view illustrating an example that paid information is displayed.

FIG. 23 is a view illustrating an example that a receipt is displayed.

FIG. 24 is a view illustrating an example that a receipt is kept.

FIG. 25 is a view illustrating an example that paid details are displayed.

FIG. 26 is a view illustrating another example that paid details are displayed.

FIG. 27 is a view illustrating an example that is switched to a payment details screen.

FIG. 28 is a view illustrating an example that a receipt is switched to a receipt storage box.

FIG. 29 is a view illustrating another example that is switched to a temporary storage screen.

FIG. 30 is a view illustrating an example that is switched to a receipt storage screen.

FIG. 31 is a view illustrating an example that a card payment is selected.

FIG. 32 is a view illustrating an example that information to be paid is displayed.

FIG. 33 is a view illustrating an example that an installment payment is selected.

FIG. 34 is a view illustrating an example that an authentication system is selected.

FIG. 35 is a view illustrating an example that details which are paid are displayed.

FIG. 36 is a flow chart illustrating a control method of a terminal apparatus according to one embodiment of the present invention.

### BEST MODE FOR CARRYING OUT THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals (or terminal apparatuses or devices) presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

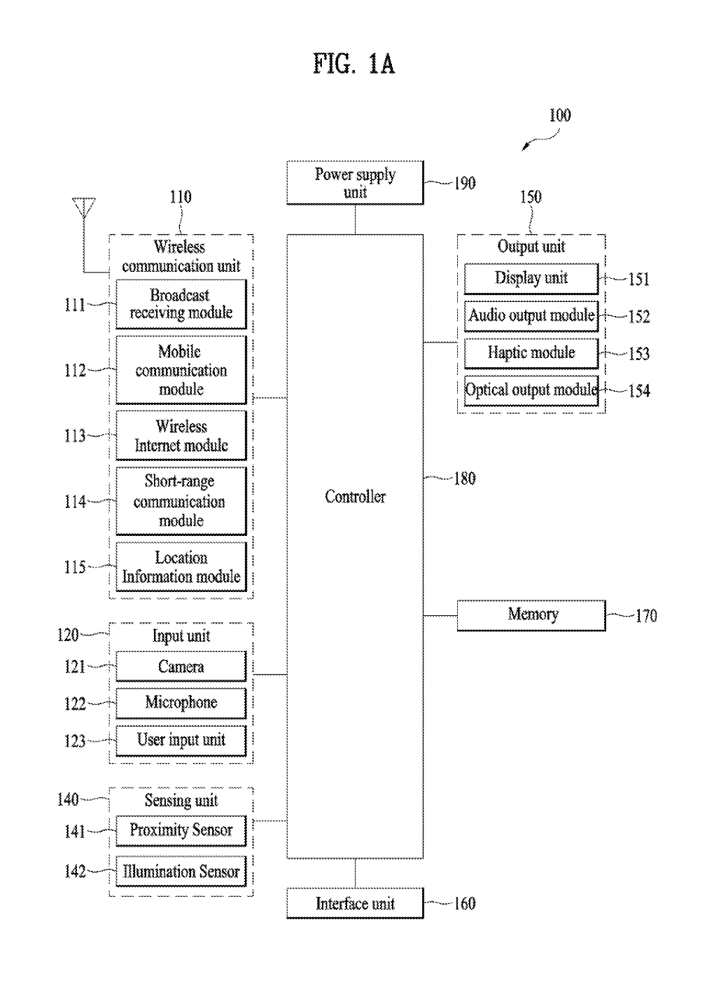

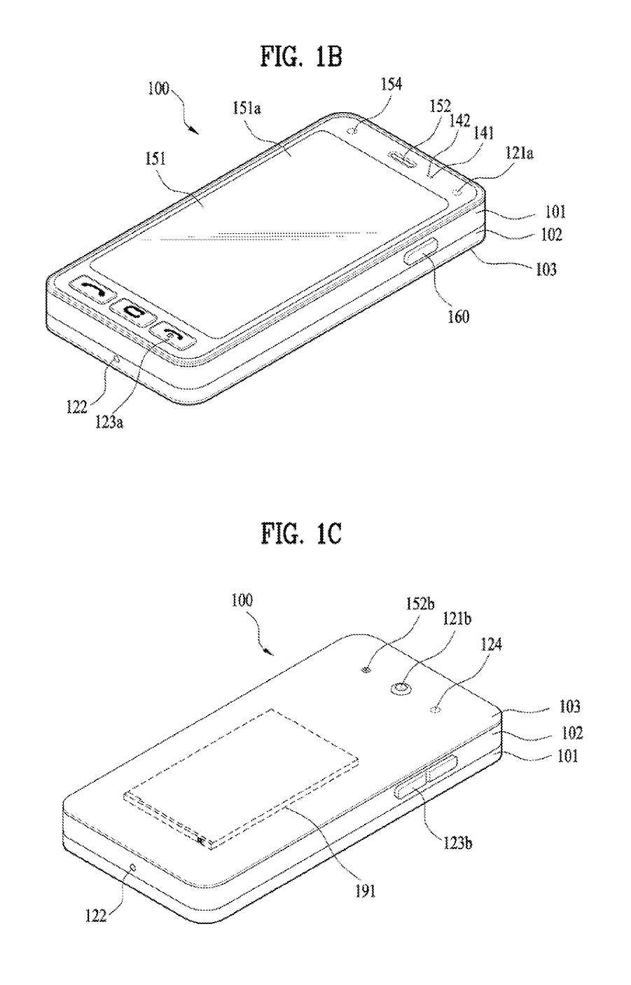

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented. Referring now to FIG. 1A, the mobile terminal 100 is shown having wireless communication unit 110 configured with several commonly implemented components.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs.

The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

All or a portion of the components described above can cooperate with each other to implement embodiments described below for operations or control of the mobile terminal apparatus.

Referring still to FIG. 1A, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE) , LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB(Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others. As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal.

In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include the first and second audio output module 152a, 152b, the proximity sensor 141, the illumination sensor 142, the first and second camera 121a, 121b, the first and second manipulating unit 123a, 123b, the microphone 122, the interface unit 160 and, so on.

FIGS. 1B and 1C depict certain components as arranged on the mobile terminal.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices.

Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

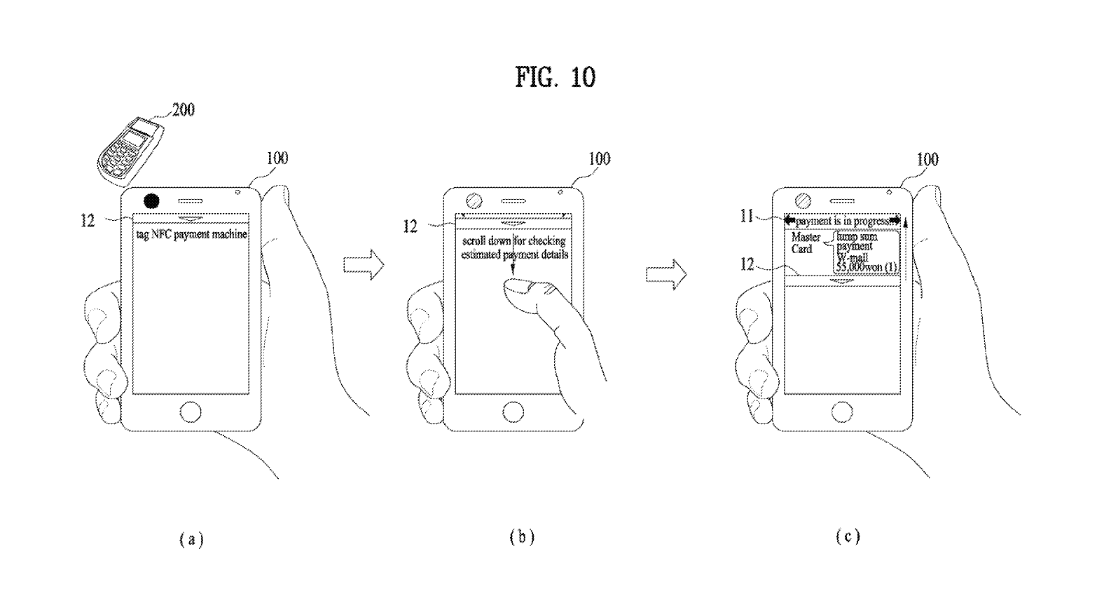

As shown in FIG. 10, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160.

Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Further preferred embodiments will be described in more detail with reference to additional drawing figures. It is understood by those skilled in the art that the present features can be embodied in several forms without departing from the characteristics thereof.

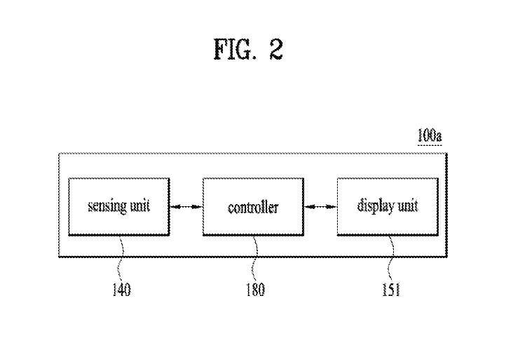

FIG. 2 is a block diagram illustrating a terminal apparatus according to one embodiment of the present invention.

Referring to FIG. 2, the terminal apparatus 100a includes a sensing unit 140, a display unit 151, and a controller 180. The sensing unit 140 may sense a preset input signal. For example, the preset input signal may include a touch gesture, a fingerprint, or vibration. The sensing unit 140 may be arranged at various positions of the terminal apparatus and sense various external signals.

For example, the sensing unit 140 may include a touch sensor (not shown). The touch sensor may be arranged together with the display unit 151. In other words, the touch sensor may be implemented in a single body with the display unit 151, and may be implemented one surface below the display unit 151. The touch sensor may sense a touch gesture of a user. That is, the sensing unit 140 may sense a touch gesture of a user.

The sensing unit 140 may include a fingerprint recognition sensor (not shown). The fingerprint recognition sensor may be arranged in a preset area of a home button or a bezel (not shown). The fingerprint recognition sensor may receive fingerprint information of a user. The fingerprint recognition sensor may additionally sense a touch gesture of a user. That is, the sensing unit 140 may receive a fingerprint of a user, or may additionally sense a touch gesture of a user.

The sensing unit 140 may include a vibration sensor (not shown) such as a gyro sensor and a geomagnetic sensor. The vibration sensor may be arranged in the terminal apparatus 100a. The vibration sensor may sense vibration of the terminal apparatus 100a. That is, the sensing unit 140 may sense vibration of the terminal apparatus 100a.

The sensing unit 140 may include at least one type of sensor. Therefore, the sensing unit 140 may sense at least one or more of various types of signals.

The display unit 151 may display contents and receive a touch gesture. As described above, the display unit 151 may be implemented together with the touch sensor to receive a touch gesture. The terminal apparatus 100a may include a payment function. The terminal apparatus 100a may set a normal payment mode or a private payment mode in accordance with a user's selection to perform a payment function. If the normal payment mode is set, the display unit 151 may display various kinds of information such as card information and card image. However, if the private payment mode is set, the display unit 151 may not display any information. Alternatively, in the private payment mode, the display unit 151 may display only minimum information which is required.

The controller 180 may activate the normal payment mode if a preset input signal is not sensed and an execution command of a payment application is received. For example, the normal payment mode may be a payment mode that displays image and various kinds of information in accordance with execution and payment steps of the application. The controller 180 may activate the private payment mode if the preset input signal is sensed. For example, the private payment mode may be a payment mode that performs a payment function without displaying any information. Otherwise, the private payment mode may be a payment mode that performs a payment function by displaying only minimum required information. Otherwise, the private payment mode may be a payment mode that displays required information on a glance view area having an automatic hiding function or outputs information using vibration or LED color.

Various embodiments of the private payment mode will be described below. The embodiments described below may be combined per step. For example, a mode ‘a’ and a mode ‘b’ may exist in a private payment function execution step, a first mode and a second mode may exist in a preparing step, and a mode I and a mode II may exist in an authentication step. In this case, the terminal apparatus and the control method may perform a total of 8 types of private payment functions by combining the private payment function execution step, the preparing step and the authentication step.

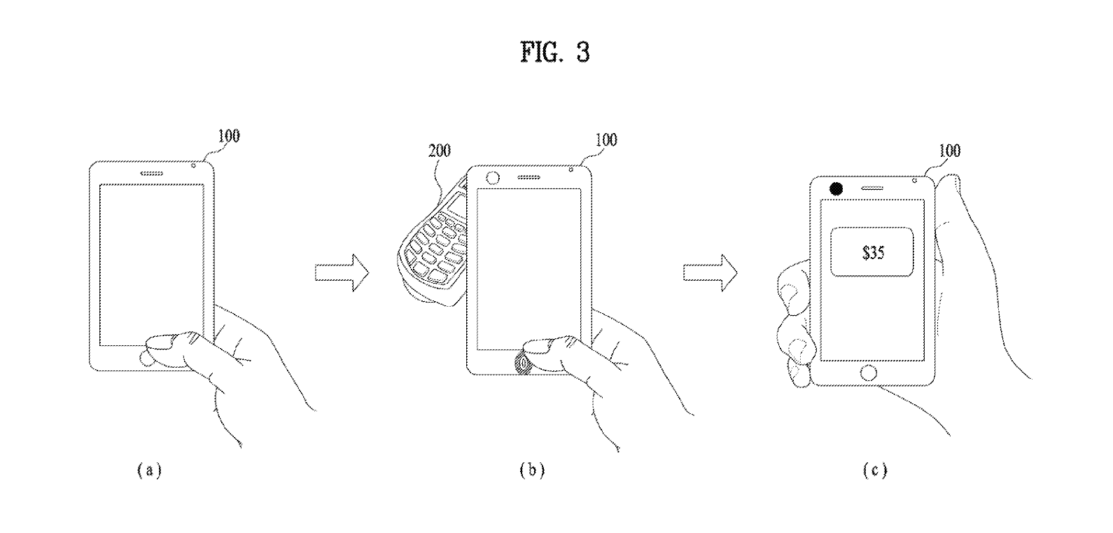

FIG. 3 is a view illustrating a terminal apparatus, which performs a private payment, according to one embodiment of the present invention.

Referring to FIG. 3(a), a terminal apparatus 100 in which a fingerprint is received is shown. The terminal apparatus 100 may include a fingerprint recognition sensor in a preset area of a home button or a bezel. As an embodiment, a user may input a fingerprint in the terminal apparatus 100 and access the terminal apparatus 100 to a payment terminal 200 (ex., POS terminal).

Referring to FIG. 3(b), a terminal apparatus 100 which performs an authentication step is shown. If a fingerprint is input to the terminal apparatus 100 and accesses the payment terminal 200, the terminal apparatus 100 may perform the private payment mode. The terminal apparatus 100 may display LED color as a first color, which is preset, to indicate execution of the private payment mode. Alternatively, the terminal apparatus 100 may output a vibration of a first pattern or a first sound, which is preset.

The user may change a payment card. The embodiment in which the payment card is changed will be described later. If the user does not change the payment card, the terminal apparatus 100 may perform payment using a preset card. The terminal apparatus 100 may display a guide for requesting a fingerprint input near the fingerprint recognition sensor to indicate an authentication request. The user may recognize a fingerprint in the fingerprint recognition sensor.

Referring to FIG. 3(b), a terminal apparatus 100 in which a payment is completed is shown. If a fingerprint is recognized, the terminal apparatus 100 may perform a payment procedure. The terminal apparatus 100 may transmit card information to a server (not shown), and the server may transmit a payment complete response to the terminal apparatus 100. Also, the server may transmit receipt data to the terminal apparatus 100.

If payment is completed, the terminal apparatus 100 may display LED color as a second color, which is preset. Alternatively, the terminal apparatus 100 may output a vibration of a second pattern or a second sound, which is preset. The terminal apparatus 100 may display paid details. The terminal apparatus 100 may perform a payment procedure in the private payment mode through the aforementioned procedure.

Various embodiments for activating the private payment mode will be described below.

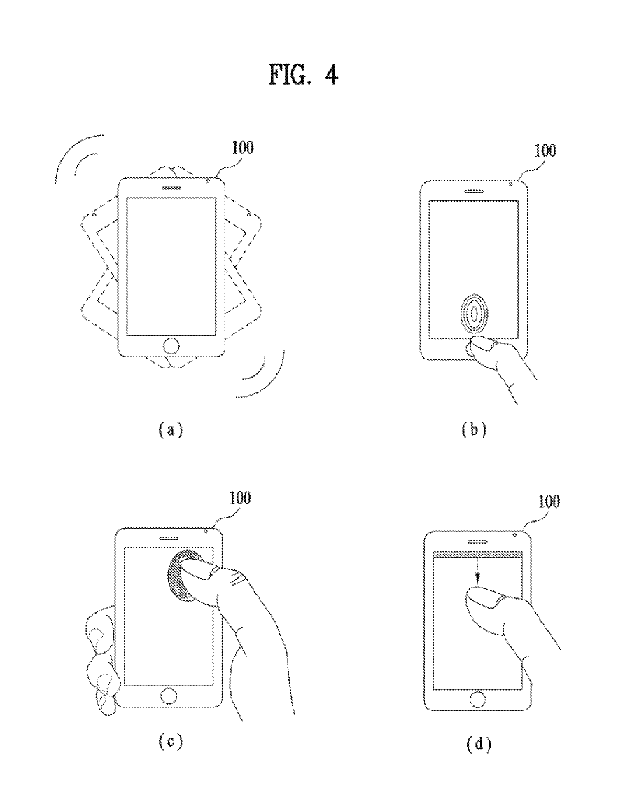

FIG. 4 is a view illustrating an example that a private payment function is activated.

The private payment function may be activated in various manners. Referring to FIG. 4(a), a terminal apparatus 100 in which a vibration gesture is received is shown. The terminal apparatus 100 may include a vibration sensor. The vibration sensor may sense vibration or action gesture of the terminal apparatus 100. The action gesture means a gesture input as action. The terminal apparatus 100 may sense direction of the action gesture, speed of the action gesture, displacement of the action gesture, or their combination. If the sensed gesture is matched with a preset gesture, the terminal apparatus 100 may perform an operation mapped into the preset gesture. For example, the terminal apparatus 100 may set an action gesture of horizontal vibration of twice and up and down vibration of one time as action for entering the private payment mode. If the user vibrates the terminal apparatus 100 twice in a horizontal direction and vibrates the terminal apparatus 100 once up and down, the terminal apparatus 100 may recognize the action gesture and activate the private payment mode. Alternatively, the terminal apparatus 100 may set an action gesture of fast vibration of fifth times as the action for entering the private payment mode. If the terminal apparatus quickly vibrates fifth times, the terminal apparatus 100 may activate the private payment mode.

Referring to FIG. 4(b), a terminal apparatus 100 to which a fingerprint is input is shown. The terminal apparatus 100 may include a fingerprint recognition sensor. The fingerprint recognition sensor may be implemented as one layer below the display unit. If the fingerprint recognition sensor is implemented as one layer below the display unit, the terminal apparatus 100 may receive the fingerprint on the display unit. Alternatively, the fingerprint recognition sensor may be arranged in the home button or a partial area of the bezel. If the fingerprint recognition sensor is arranged in the home button, the terminal apparatus 100 may receive the fingerprint on the home button. If the fingerprint recognition sensor is arranged in the partial area of the bezel, the terminal apparatus 100 may receive the fingerprint on the bezel on which the fingerprint recognition sensor is arranged. The terminal apparatus 100 may display a fingerprint guide for on an area of the display unit adjacent to the fingerprint recognition sensor to recognize the fingerprint guide. If the input fingerprint is matched with a stored fingerprint, the terminal apparatus 100 may activate the private payment mode.

Referring to FIG. 4(c), a terminal apparatus 100 to which a touch command is input in a specific area is shown. The terminal apparatus 100 may include a touch recognition sensor in an area of the display unit. Therefore, the terminal apparatus 100 may recognize a touch gesture input on the display unit. The terminal apparatus 100 may activate the private payment mode if the touch gesture is received in the preset area for a preset time or more. To prevent an unwanted press from occurring, the terminal apparatus 100 may deactivate the private payment mode if a payment procedure is not performed for a preset time or more.

Referring to FIG. 4(d), a terminal apparatus 100 to which a command for activating a glance view is input is shown. The glance view means a hidden display area enlarged by a swipe gesture from a specific corner of the display unit. The swipe gesture means a gesture that touches one point of the display unit and moves to another point while maintaining the touch. The swipe gesture may include a drag gesture, a flicking gesture, a scroll gesture, etc.

The terminal apparatus 100 may receive the swipe gesture from the specific corner area of the display unit. The terminal apparatus 100 may display the glance view on the basis of the swipe gesture. The terminal apparatus 100 may display the glance view and at the same time activate the private payment mode. The terminal apparatus 100 may display a current mode or a current state on the glance view.

The terminal apparatus 100 may activate the private payment mode through the command for activating the glance view but display the payment step or notification in a state that the private payment mode is executed. In other words, the terminal apparatus 100 may execute the private payment mode through the command for activating the glance view. Alternatively, the terminal apparatus 100 may execute the private payment mode through another command. The terminal apparatus 100 may display a notification message of the current step (ex., execution of private payment mode, payment is in progress, payment is completed, etc.) if the command for activating the glance view is input thereto.

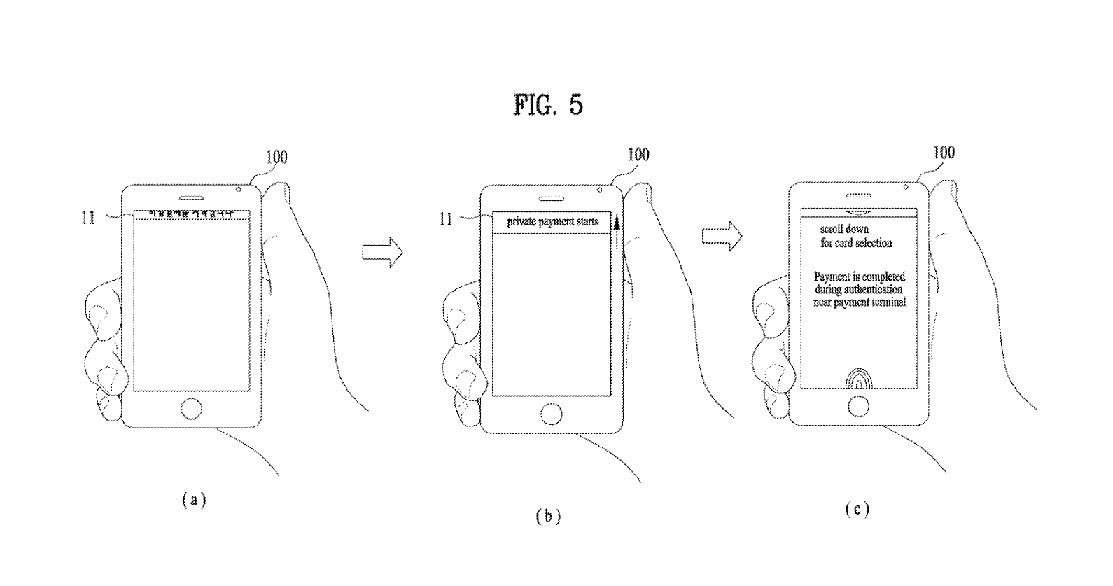

FIG. 5 is a view illustrating an example that a glance view area is displayed.

Referring to FIG. 5(a), a terminal apparatus 100 for displaying a glance view is shown. The terminal apparatus 100 may receive a preset command and execute a private payment mode. In a state that the private payment mode is executed, the terminal apparatus 100 may receive a swipe gesture. If the swipe gesture is input in the preset corner area of the display unit, the glance view may be displayed. As shown in FIG. 5(a), the user may input a swipe gesture for downward movement in a corner area on the display unit. The terminal apparatus 100 may display the glance view while downwardly moving the glance view along the swipe gesture. The glance view may include a notification window 11. The notification window 11 may display the current step or notification of the private payment mode. Alternatively, the terminal apparatus 100 may receive the swipe gesture and execute the private payment mode if the glance view is displayed.

Referring to FIG. 5(b), a terminal apparatus 100 from which a glance view disappears is shown. The glance view may maintain its display of a touch of the swipe gesture is maintained. The glance view may disappear if the touch of the swipe gesture ends. If the glance view disappears, the notification window 11 may also disappear. Even though the glance view disappears, the private payment mode may be maintained.

Referring to FIG. 5(c), a terminal apparatus 100 for requesting authentication is shown. The terminal apparatus 100 may display a guide or notification message for displaying a glance view even though the glance view disappears. The terminal apparatus 100 may execute the private payment mode and request authentication. The authentication mode may include a fingerprint authentication mode. The terminal apparatus 100 may display a fingerprint guide for requesting fingerprint authentication near the fingerprint recognition sensor. The terminal apparatus 100 may display a message for requesting tagging for the payment terminal. If the user tags the terminal apparatus 100 for the payment terminal while inputting a fingerprint, payment may be completed.

Meanwhile, the terminal apparatus 100 may display the glance view if the swipe gesture for displaying the glance view is input thereto. The terminal apparatus 100 may display a message indicating the current step on the notification window 11.

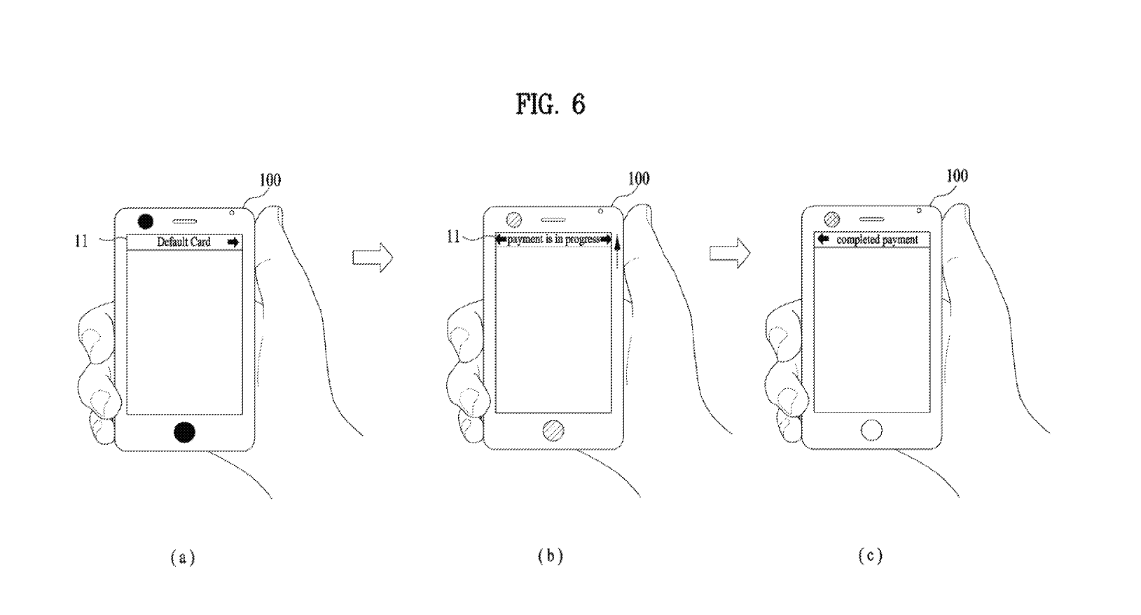

FIG. 6 is a view illustrating an example that a payment step is notified from a private payment mode.

Referring to FIG. 6(a), a terminal apparatus 100 in which a private payment mode is activated is shown. The terminal apparatus 100 may activate the private payment mode in various manners. If the private payment mode is activated, the terminal apparatus 100 may display a message indicating the current step on a notification window 11 of a glance view. The notification window 11 of the glance view may display an arrow for progress to next step. The terminal apparatus 100 may execute a payment progress step in accordance with an operation for tagging the payment terminal but execute a payment progress step by receiving a command for selecting an arrow or switching a screen to an arrow direction.

Meanwhile, the terminal apparatus 100 may display the step of the private payment mode in another manner. The terminal apparatus 100 may include LED that may display various colors. The LED may be arranged in a bezel area independently. Alternatively, the LED may be arranged in a home button area. The LED may display different colors per each step of the private payment mode. As an embodiment, if the private payment mode of the LED is executed, the LED may display a green color. Also, the notification window 11 of the glance view may display information on card setup or set card.

Referring to FIG. 6(b), a terminal apparatus 100 which is performing a payment is shown. If the payment is in progress, the notification window 11 of the glance view may display a message indicating that payment is in progress. For example, the step of performing a payment may include a standby state of tagging the payment terminal or an authentication request step. The notification window 11 of the glance view may display an arrow that may be switched from a previous step or next step. The terminal apparatus 100 may return to the previous step or advance to next step in accordance with the selected arrow. The LED may change a color in accordance with switching of the step. As an embodiment, when the current step is the step of performing a payment, the LED may change a red color to an orange color and display the changed color.

Referring to FIG. 6(c), a terminal apparatus 100 in which a payment is completed is shown. If the payment is completed, the notification window 11 of the glance view may display a message indicating ‘completed payment’. The notification window 11 of the glance view may display an arrow that may switch to a previous step. The LED may change a color in accordance with switching of the step. As an embodiment, when the current step is a payment complete step, the LED may change a color from an orange color to a yellow color and display the changed color.

A terminal apparatus 100 that includes LED arranged in a bezel area and LED arranged in a home button area is shown in FIG. 6. However, the terminal apparatus 100 may include LED arranged in a bezel area or LED arranged in a home button area. Alternatively, the terminal apparatus 100 may not include LED. If the terminal apparatus does not include LED, the terminal apparatus 100 may display the step on only the notification window 11 of the glance view. Also, the terminal apparatus 100 may change the color of the notification window 11 of the glance view in accordance with switching of the step.

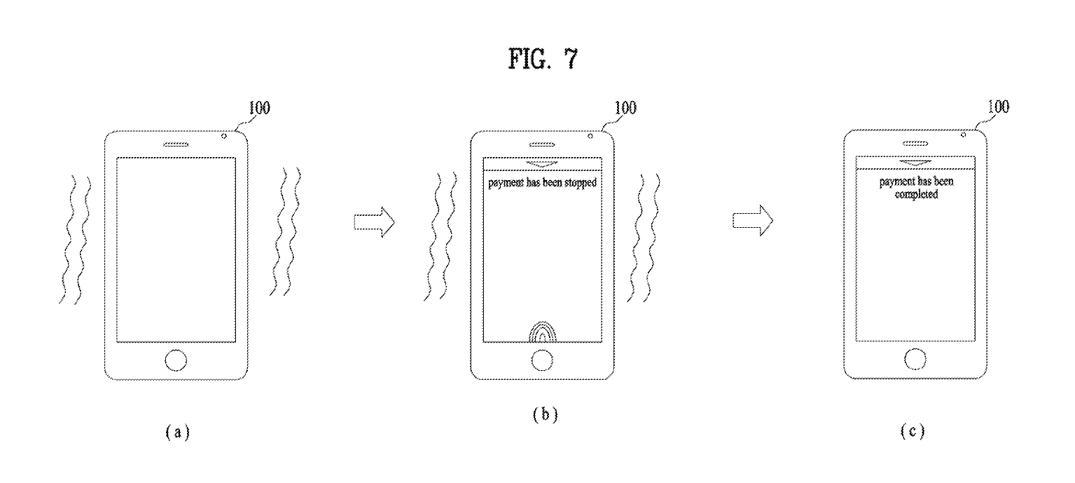

FIG. 7 is a view illustrating another example that a payment stage is notified from a private payment mode.

Referring to FIG. 7(a), a terminal apparatus 100 for outputting a first vibration is shown. The terminal apparatus 100 may activate the private payment mode in various manners. The private payment mode may be a mode for performing a payment procedure without displaying data such as card information. Therefore, the terminal apparatus 100 may output a first vibration which is preset, if the private payment mode is activated. The user may recognize that the terminal apparatus 100 has activated the private payment mode if the first vibration is sensed. If the user does not change a card, the terminal apparatus 100 may perform the payment procedure in a preset card.

Referring to FIG. 7(b), a terminal apparatus 100 for outputting a second vibration is shown. The terminal apparatus 100 may stop the payment procedure in the middle of payment. The terminal apparatus 100 may stop the payment procedure in accordance with a command of the user or occurrence of an error. If the payment is stopped, the terminal apparatus 100 may output a second vibration which is preset. Also, the terminal apparatus 100 may additionally display a message indicating payment interruption.

Referring to FIG. 7(c), a terminal apparatus 100 in which a payment is completed is shown. The terminal apparatus 100 may again perform the payment procedure in accordance with a correction of an error or a progress command of the user. The terminal apparatus 100 may output a third vibration which is preset, if the payment is completed. Alternatively, the terminal apparatus 100 may output the third vibration which is preset if no error occurs and the payment is completed. Also, the terminal apparatus 100 may additionally display a message indicating completed payment.

The embodiment for activating the private payment mode and the embodiment for displaying notification per step have been described as above. The embodiment for changing a basically set card to another card will be described below.

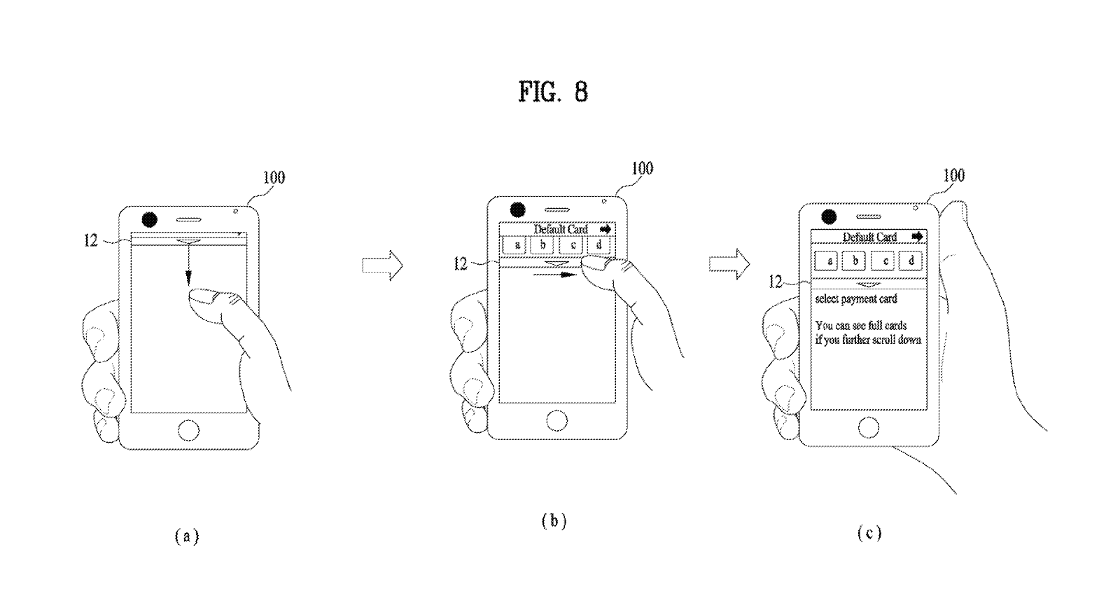

FIG. 8 is a view illustrating an example that a card is changed.

Referring to FIG. 8(a), a terminal apparatus 100 for displaying a glance view is shown. The terminal apparatus 100 may activate the private payment mode in accordance with various embodiments. The terminal apparatus 100 may display the glance view on the basis of a swipe gesture. The glance view may include a guide 12 indicating a notification window and a glance view area. As an embodiment, if the guide 12 of the glance view area is touched and moves downwardly, the terminal apparatus 100 may display the glance view area. Meanwhile, if the terminal apparatus 100 includes LED, the terminal apparatus 100 may display the LED as a first color in accordance with execution of the private payment mode.

Referring to FIG. 8(b), a terminal apparatus 100 in which a gesture for fixing a glance view is received is shown. As described above, the glance view area may disappear if a touch is removed. However, if a swipe gesture moving in a second direction is input to the terminal apparatus 100, the terminal apparatus 100 may fixe the glance view area. As an embodiment, the user may input the swipe gesture headed for a downward direction from a top portion of the display unit. The terminal apparatus 100 may downwardly move the guide 12 and display the glance view area. The user may input the swipe gesture in a right direction while maintaining a touch of the swipe gesture headed for a downward direction. The terminal apparatus 100 may fix the glance view area in accordance with the swipe gesture.

Referring to FIG. 8(c), a terminal apparatus 100 in which a plurality of cards are displayed is shown. The terminal apparatus 100 may include a notification window and a guide 12 in a glance view area. The plurality of cards may be displayed between the notification window and the guide 12. The plurality of cards may be the cards of which information is stored in the terminal apparatus 100. The terminal apparatus 100 may display the currently set card in an active state and display the other cards in a deactivated state. The user may input a swipe gesture in a left and right direction on a card image. The terminal apparatus 100 may move the active state in accordance with the swipe gesture. That is, the terminal apparatus 100 may change a card, which is currently set to a basic card, to another card. Even though the glance view area is fixed without disappearing, if the swipe gesture is input on the guide 12, the glance view area may be changed in accordance with the swipe gesture.

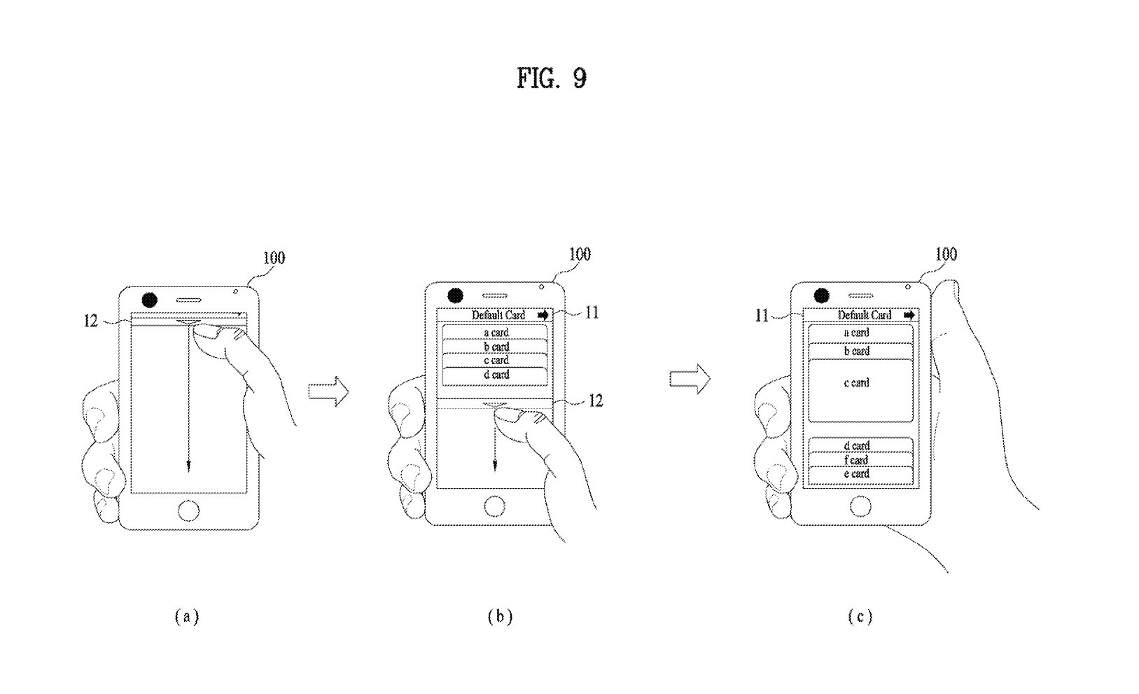

FIG. 9 is a view illustrating an example that all cards are displayed.

Referring to FIG. 9(a), a terminal apparatus 100 to which a swipe gesture is input is shown. A user may scroll down the guide 12 of the glance view area in an opposite direction. The terminal apparatus 100 may display a glance view in accordance with the user's gesture.

Referring to FIG. 9(b), a terminal apparatus 100 for displaying a full image of a card is shown. A user may move the guide 12 of the glance view area in an opposite direction by inputting the swipe gesture. The terminal apparatus 100 may display a mini view of a card stored between the notification window 11 and the guide 12 in accordance with the swipe gesture. The user may move the guide 12 to a threshold line or more by continuously inputting the swipe gesture. For example, the terminal apparatus 100 may set the threshold line to a middle area of the display unit. The terminal apparatus 100 may display a full image of the stored card in accordance with the swipe gesture if the guide 12 exceeds the threshold line.

Referring to FIG. 9(c), a terminal apparatus 100 in which a full image of a card is displayed is shown. If the guide 12 exceeds the threshold line in accordance with the swipe gesture and a touch of the swipe gesture ends, the terminal apparatus 100 may display a full image of a card on a full screen. The terminal apparatus 100 may select one card in accordance with a touch command of the user. The terminal apparatus 100 may perform a payment procedure by using the selected card.

Meanwhile, as shown in FIG. 8, the guide 12 may move in accordance with the swipe gesture even in a state that the glance view is fixed. If the guide 12 exceeds the threshold line in accordance with the input swipe gesture, the terminal apparatus 100 may display the full image of the card on the full screen.

The terminal apparatus 100 may set an estimated payment amount or an installment month before performing a payment.

FIG. 10 is a view illustrating a method for checking a payment amount in accordance with one embodiment of the present invention.

Referring to FIG. 10(a), a terminal apparatus 100 tagged with the payment terminal 200 is shown. If a card to be paid is set, the terminal apparatus 100 may perform a payment using a card which is set. The terminal apparatus 100 may request authentication. As an embodiment, an authentication mode may be a fingerprint authentication mode. The terminal apparatus 100 may display a fingerprint guide for authentication. The terminal apparatus 100 may display the guide 12 to indicate a glance view position.

The terminal apparatus 100 may access the payment terminal 200 while receiving a fingerprint. If the terminal apparatus 100 accesses the payment terminal 200 while receiving a fingerprint, the terminal apparatus 100 may perform a payment procedure.

Meanwhile, the terminal apparatus 100 may access the payment terminal 200 without receiving a fingerprint. If the terminal apparatus 100 accesses the payment terminal 200 without receiving a fingerprint, the terminal apparatus 100 may receive information such as an estimated payment amount.

If the terminal apparatus 100 includes LED, the terminal apparatus 100 may display a color indicating a payment preparing step. Steps of the private payment mode may be set in various manners. For example, the steps of the private payment mode may be set to a payment preparing step, a payment progressing step, and a payment completing step. Otherwise, the steps of the private payment mode may be set to a card setting step, a payment progressing step, and a payment completing step. Otherwise, the steps of the private payment mode may be set to detailed steps of the aforementioned steps.

Referring to FIG. 10(b), a terminal apparatus 100 that has received information such as an estimated payment amount is shown. The glance view may include received information. The terminal apparatus 100 may display a notification indicating that there is received information in the glance view. Also, if the terminal apparatus includes LED, the terminal apparatus 100 may change a color displayed to indicate a payment progressing step. The user may input the swipe gesture to allow the glance view to be displayed. If the guide 12 of the glance view area is touched and then moves, the terminal apparatus 100 may display the glance view area.

Referring to FIG. 10(c), a terminal apparatus 100 that has displayed received information on the glance view area is shown. The terminal apparatus 100 may display a glance view area in accordance with an input swipe gesture. The terminal apparatus 100 may display the received information between the notification window 11 and the guide 12 of the glance view area. As an embodiment, the terminal apparatus 100 may include a set card, an estimated payment amount, an installment month, etc. If the touch of the swipe gesture ends, the terminal apparatus 100 may hide the glance view area.

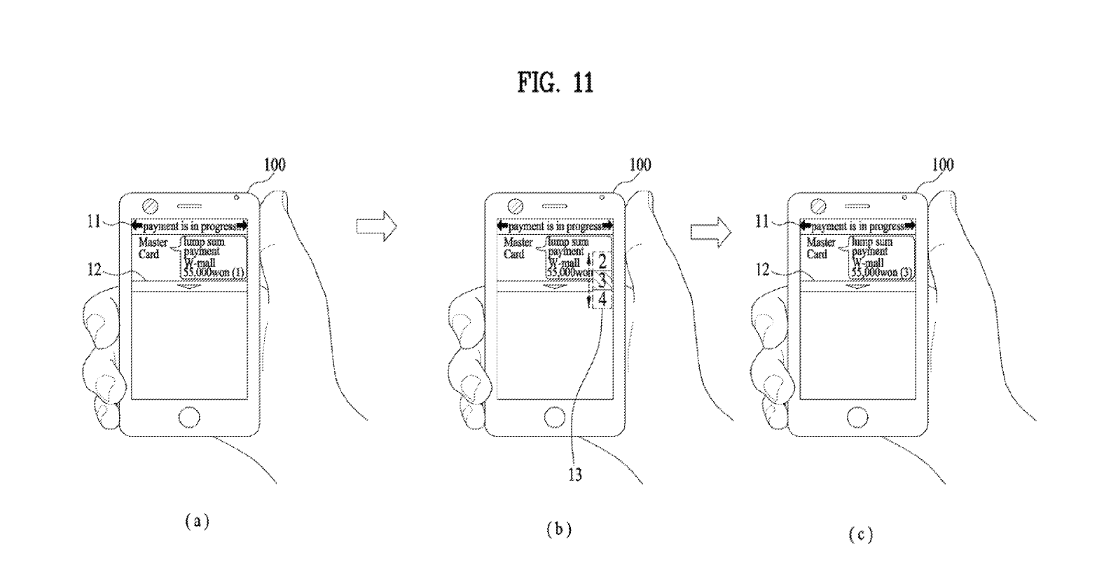

FIG. 11 is a view illustrating a method for selecting an installment payment according to one embodiment of the present invention.

Referring to FIG. 11(a), a terminal apparatus 100 in which received information is displayed is shown. The terminal apparatus 100 may display the received information on the glance view area between the notification window 11 and the guide 12. For example, the received information may include an estimated payment amount, an installment month, etc. The user may fix the glance view area by inputting a swipe gesture moving a preset direction. If the glance view area is fixed, the terminal apparatus 100 may maintain the display of the glance view area even though a touch input ends. The user may press the glance view area on which the received information is displayed, for a long time.

Referring to FIG. 11(b), a terminal apparatus 100 in which a menu capable of selecting an installment month is displayed is shown. The terminal apparatus 100 may display a menu 13 capable of selecting an installment month in accordance with the user's long press. The user may input the swipe gesture to move the menu up and down. The terminal apparatus 100 may change a number on the menu in accordance with the input swipe gesture. The terminal apparatus 100 may select one number in accordance with the user's selection.

Referring to FIG. 11(c), a terminal apparatus 100 in which an installment month is changed is shown. The terminal apparatus 100 may change the installment month if one number is selected. Referring to FIG. 11, the installment month marked with (1) in FIG. 11(a) has been marked with (3) in FIG. 11(c). That is, the terminal apparatus 100 has changed a payment method of a lump sum to installment of three months. The terminal apparatus 100 may display the changed installment month. If the terminal apparatus 100 includes LED, the terminal apparatus 100 may output whether the installment month has been changed, through the LED. As an embodiment, if the installment month is changed, the terminal apparatus 100 may flicker the LED for a preset time.

The user may select a card to be paid and progress the payment. Alternatively, the user may select an estimated payment amount and whether to perform installment and then perform the payment. The terminal apparatus 100 may request the user of authentication to perform the payment.

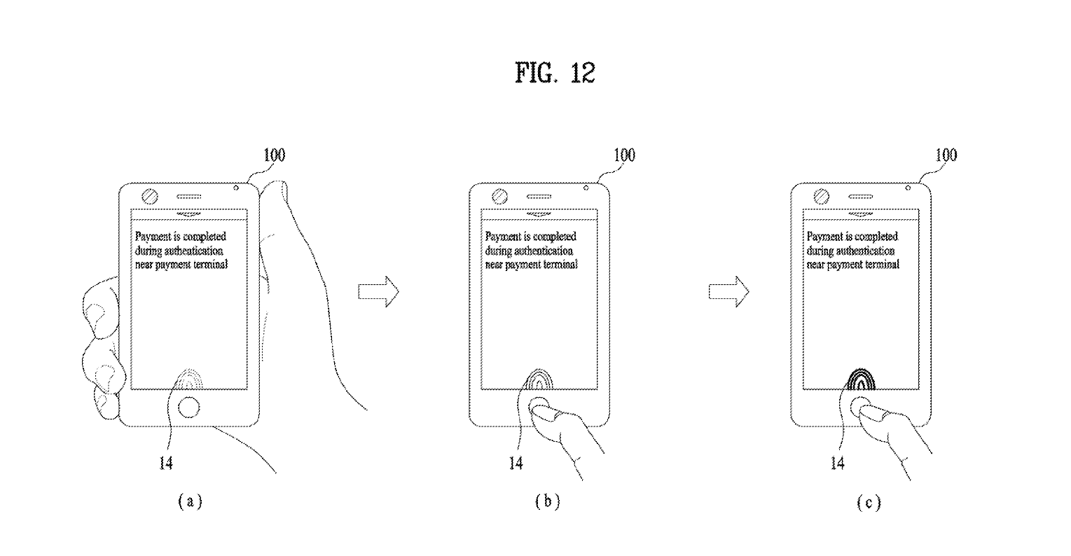

FIG. 12 is a view illustrating a fingerprint authentication system according to one embodiment of the present invention.

Referring to FIG. 12(a), a terminal apparatus 100 for requesting fingerprint authentication is shown. The private payment mode is a mode that does not display a screen such as card information on a display. Therefore, the terminal apparatus 100 may display a fingerprint guide 14 to provide a user with a notification. The terminal apparatus 100 may flicker the fingerprint guide as a first color until a fingerprint of the user is input. Also, if the terminal apparatus 100 includes LED, the terminal apparatus 100 may also flicker the LED. The user may input a fingerprint by seeing the fingerprint guide 14.

Referring to FIG. 12(b), a terminal apparatus 100 in which a fingerprint is received is shown. If the fingerprint is input, the terminal apparatus 100 may determine whether the input fingerprint is matched with a stored fingerprint. Also, the terminal apparatus 100 may gradually change a color of the fingerprint guide 14 if the fingerprint is input. For example, the terminal apparatus 100 may change the fingerprint guide 14 which is flickering as a red color, to a light red.

Referring to FIG. 12(c), a terminal apparatus 100 that has recognized a fingerprint is shown. The terminal apparatus 100 may determine whether the input fingerprint is matched with a stored fingerprint by scanning and analyzing the input fingerprint. If the input fingerprint is matched with the stored fingerprint, the terminal apparatus 100 may complete fingerprint authentication. If fingerprint authentication is completed, the terminal apparatus 100 may change a color of the fingerprint guide 14. For example, the terminal apparatus 100 may change the color of the fingerprint guide 14 to a blue color. The terminal apparatus 100 may stop flickering of the fingerprint guide 14. Also, if the terminal apparatus includes LED, the terminal apparatus 100 may stop flickering of the fingerprint guide 14. After fingerprint authentication is completed, if the terminal apparatus 100 accesses the payment terminal, flickering of the LED may be stopped. Alternatively, if the terminal apparatus 100 accesses the payment terminal simultaneously with fingerprint authentication, the payment may be completed.

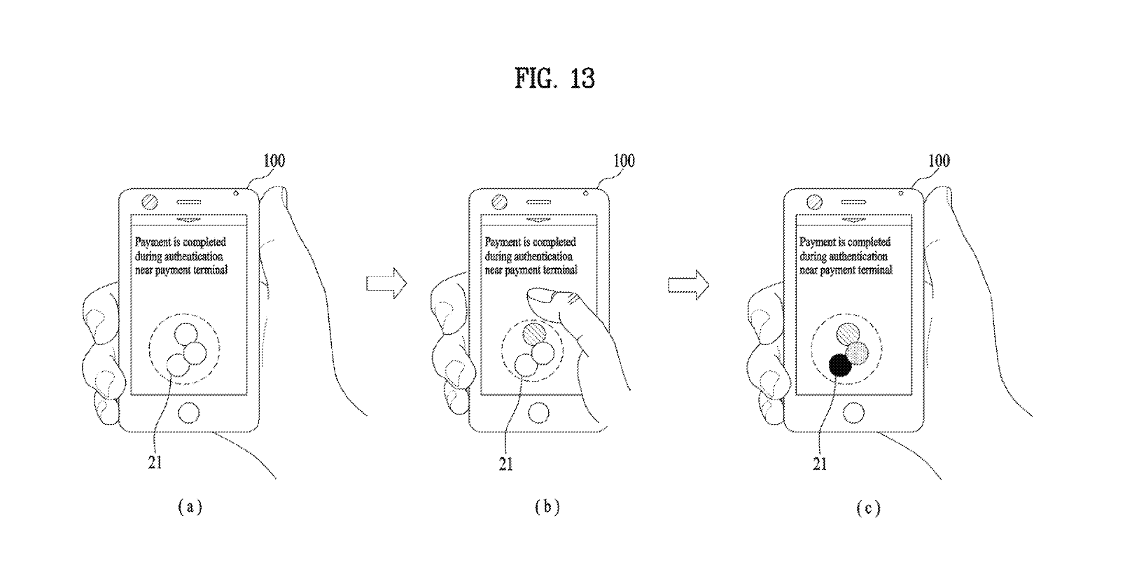

FIG. 13 is a view illustrating a color pattern authentication system according to one embodiment of the present invention.

Referring to FIG. 13(a), a terminal apparatus 100 for requesting color pattern authentication is shown. The terminal apparatus 100 may request the user of authentication. The color pattern authentication system is a type of an authentication mode. The color pattern authentication system is a system in which authentication is completed if a color pattern matched with a preset color pattern is input.

As an embodiment, a pattern of a red color, a green color and an orange color may be set to a preset pattern. The terminal apparatus 100 may display a color on a first figure while periodically changing the color. For example, the terminal apparatus 100 may display the color of the first figure for a randomly preset time. For example, the preset time may be set to 1 second.

Since the first color of the preset pattern is a red color, the user may select the red color when the red color is displayed on the first figure. If the red color is selected as the color of the first figure, the terminal apparatus 100 may maintain the color of the first figure as the red color and display a color of a second figure in due order. Since the second color of the preset pattern is a green color, the user may select the green color when the green color is displayed on the second figure. If the green color is selected as the color of the second figure, the terminal apparatus 100 may maintain the color of the second figure as the green color and display a color of a third figure in due order. Since the third color of the preset pattern is an orange color, the user may select the orange color when the orange color is displayed on the third figure. If the orange color is selected as the color of the third figure, the terminal apparatus 100 may maintain the color of the third figure as the orange color.

The terminal apparatus 100 may determine whether the pattern of red, green and orange colors, which is the pattern of the selected color, is the same as the preset color pattern. Since the pattern of the selected color is the same as the preset color pattern, the terminal apparatus 100 may complete authentication.

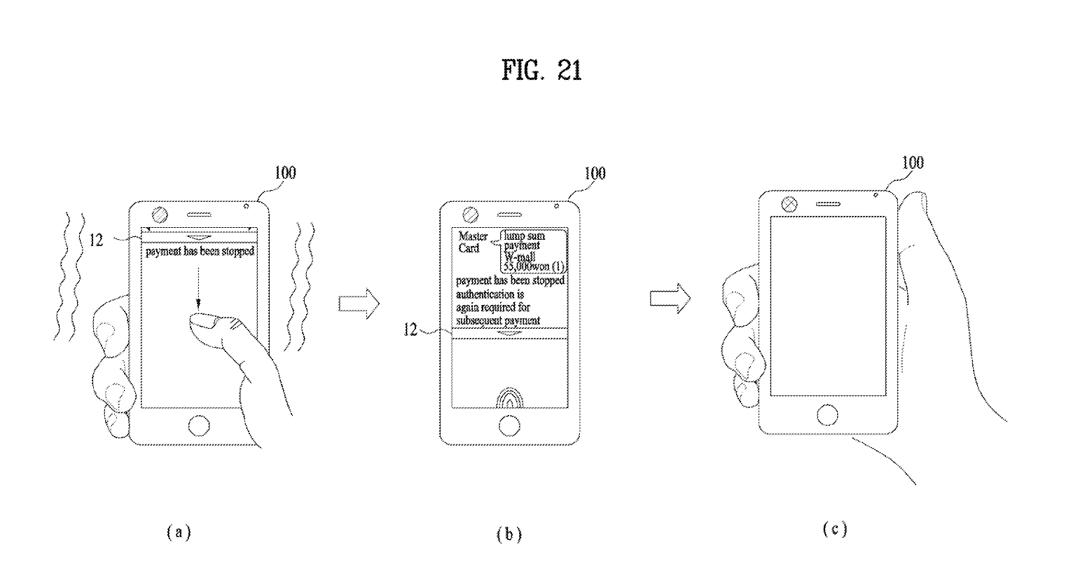

As described above, the terminal apparatus 100 may display colors of a first figure of a color pattern FIG. 21 while changing the colors in due order. The terminal apparatus 100 may display the colors by flickering the LED.

Referring to FIG. 13(b), a terminal apparatus 100 for selecting a color pattern is shown. As described above, the terminal apparatus 100 may display the colors of the first figure of the color pattern FIG. 21 in due order, and if the first color of the pattern is displayed on the first figure, the user may select the displayed color. Similarly, the user may select colors with respect to second and third figures.

Referring to FIG. 13(c), a terminal apparatus 100 in which color pattern authentication is completed is shown. The terminal apparatus 100 may compare the color pattern selected from the color pattern FIG. 21 with a preset color pattern. If the selected color pattern is matched with the preset color pattern, the terminal apparatus 100 may complete authentication. After color pattern authentication is completed, if the terminal apparatus 100 accesses the payment terminal, the payment may be completed. Alternatively, if the terminal apparatus 100 accesses the payment terminal simultaneously with color pattern authentication, the payment may be completed.

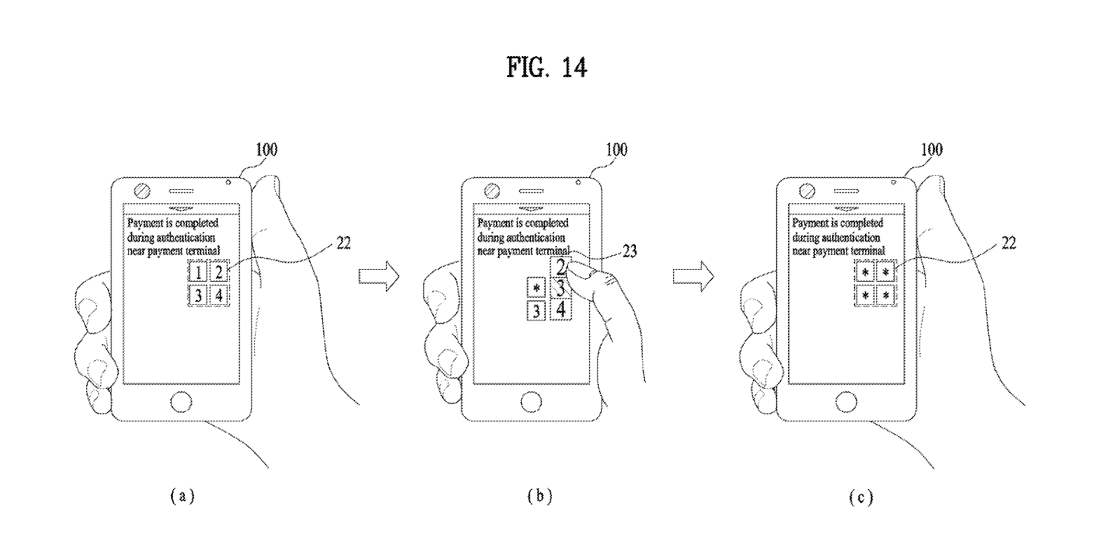

FIG. 14 is a view illustrating a password authentication system according to one embodiment of the present invention.

Referring to FIG. 14(a), a terminal apparatus 100 for requesting password authentication is shown. The terminal apparatus 100 may display a password input area 22 to request password authentication. The terminal apparatus 100 may display the password input area 22 on a right area of a screen if it is determined that the user grips the terminal apparatus with his/her right hand. The terminal apparatus 100 may display the password input area 22 on a left area of a screen if it is determined that the user grips the terminal apparatus with his/her left hand. Therefore, the user may input a password by using a thumb finger in a state that the user grips the terminal apparatus 100.

If the terminal apparatus 100 includes LED, the LED may be flickered periodically. The user may select a first window of the password input area 22.

Referring to FIG. 14(b), a terminal apparatus 100 in which a password is input in due order is shown. If the first window of the password input area 22 is selected, the terminal apparatus 100 may display the first window to be identified from another window. For example, the terminal apparatus 100 may brightly display the selected window and thickly display an edge of the selected window. The terminal apparatus 100 may display a menu 23 that may input a number. If the user inputs a swipe gesture up and down on the menu 23 for number input, the terminal apparatus 100 may change the number in response to the input swipe gesture. If the user selects one number, the terminal apparatus 100 may display a preset mark (ex., ‘*’) on the first window. The terminal apparatus 100 may receive a number even with respect to the other windows in accordance with the aforementioned method.

Referring to FIG. 14(c), a terminal apparatus 100 in which password authentication is completed is shown. If a number for the password input area 22 is input, the terminal apparatus 100 may compare the input number with a preset password. The terminal apparatus 100 may complete authentication if the input number is matched with the preset password. If authentication is completed, the terminal apparatus 100 may stop flickering of the LED.

After password authentication is completed, if the terminal apparatus accesses the payment terminal, the payment may be completed. Alternatively, if the terminal apparatus 100 accesses the payment terminal simultaneously with password authentication, the payment may be completed.

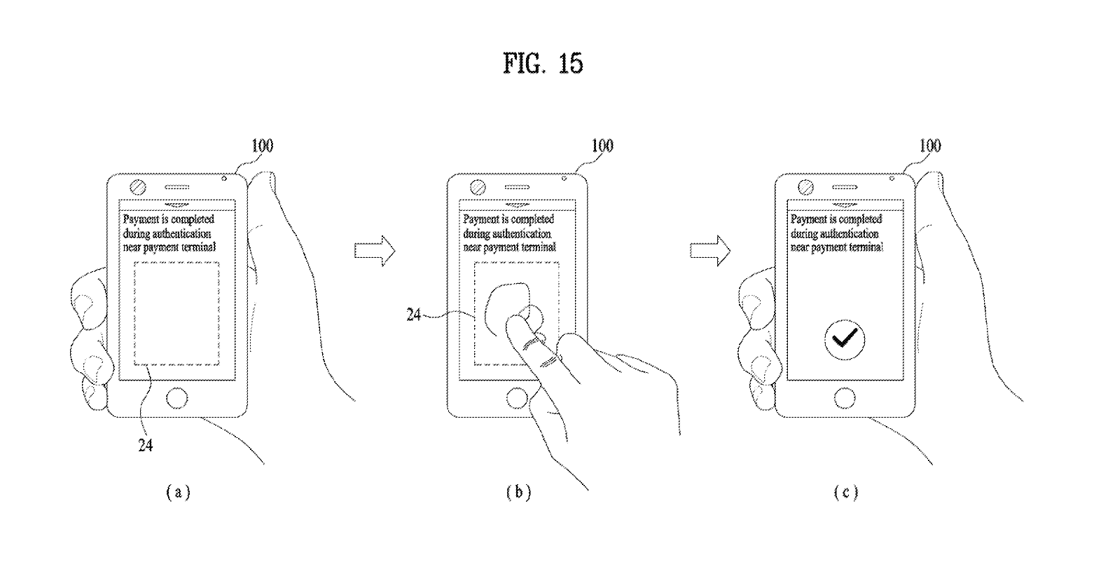

FIG. 15 is a view illustrating a signature authentication system according to one embodiment of the present invention.

Referring to FIG. 15(a), a terminal apparatus 100 for requesting signature authentication is shown. The terminal apparatus 100 may request the user of signature authentication. The terminal apparatus 100 may display a signature input area 24 on the display unit. If the terminal apparatus 100 includes LED, the terminal apparatus 100 may flicker the LED.

Referring to FIG. 15(b), a terminal apparatus 100 to which a signature is input is shown. The user may input a signature to the signature input area 24. The terminal apparatus 100 may determine whether the input signature is matched with a preset signature. The preset signature may be a signature on a card which is taken, or a signature input from the user during card registration.

Referring to FIG. 15(c), a terminal apparatus 100 in which signature authentication is completed is shown. The terminal apparatus 100 may receive a signature by means of the user's writing. Even though the same user performs the same signature, a size and a shape of the signature may be changed a little. Therefore, if the preset signature is matched with the input signature at a certain rate or more, the terminal apparatus 100 may determine that the signatures are matched with each other. As an embodiment, the terminal apparatus 100 may calculate a matching rate considering a shape of a preset area of the signature and rate between the preset areas. The terminal apparatus 100 may determine that the input signature is matched with the preset signature if the matching rate between input signature and the preset signature is 90% or more.

If the signatures are matched with each other, the terminal apparatus 100 may authentication. If authentication is completed, the terminal apparatus 100 may stop flickering of the LED. After signature authentication is completed, if the terminal apparatus 100 accesses the payment terminal, the payment may be completed. Alternatively, if the terminal apparatus 100 accesses the payment terminal simultaneously with signature authentication, the payment may be completed.

The various authentication systems have been described as above. However, the terminal apparatus 100 perform the authentication procedure in a selected one of a plurality of methods.

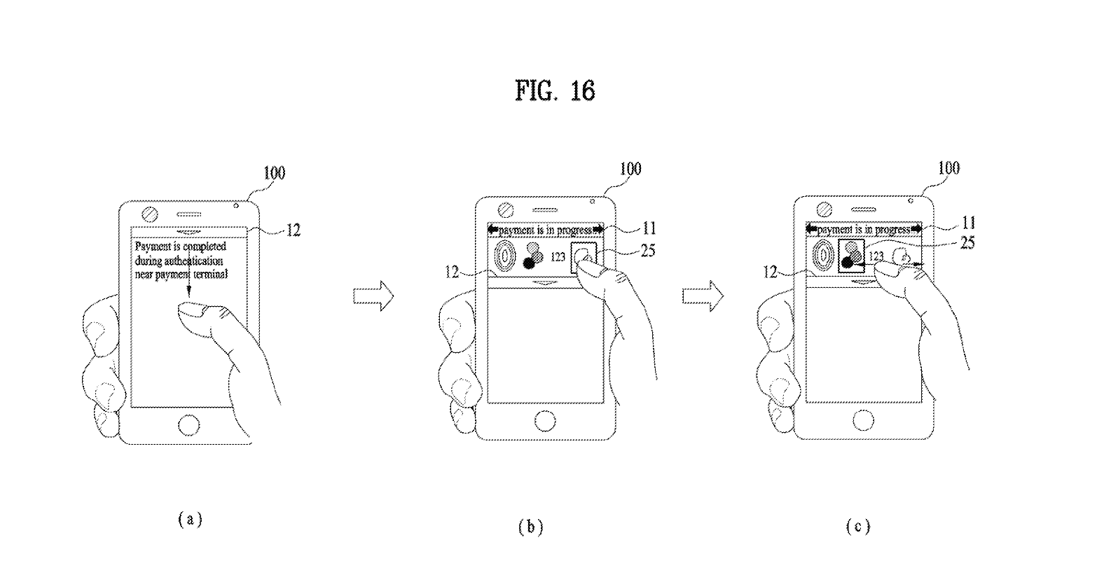

FIG. 16 is a view illustrating a method for selecting an authentication system according to one embodiment of the present invention.

Referring to FIG. 16(a), a terminal apparatus 100 to which a swipe gesture is input is shown. The user may input the swipe gesture. If the swipe gesture is input on a guide 12 on a glance view area, the terminal apparatus 100 may display the glance view area in response to the input swipe gesture.

Referring to FIG. 16(b), a terminal apparatus 100 for displaying a plurality of authentication systems is shown. The user may fix the glance view area if the swipe gesture moving in a left or right direction is input while a touch is maintained in the displayed glance view area.

The terminal apparatus 100 may perform the authentication step of the steps of the private payment mode. The terminal apparatus 100 may display at least one authentication system between the notification window 11 and the guide 12 of the glance view. For example, the terminal apparatus 100 may display fingerprint authentication, color pattern authentication, password authentication, signature authentication, etc. The user may select an authentication system by touching one of the displayed authentication systems. The terminal apparatus 100 may move a selection mark 25 in accordance with the authentication system touched by the user.

Referring to FIG. 16(c), a terminal apparatus 100 for selecting one authentication system is shown. If the user inputs the swipe gesture in a left and right direction, the terminal apparatus 100 may move the selection mark 25 in response to the input swipe gesture. The user may touch an empty space of a screen when the selection mark 25 is located in a desired authentication system. The empty space of the screen may be an area below the guide 12, or a left or right area in which the authentication system is displayed. If the empty space of the screen is touched, the terminal apparatus 100 may execute the authentication system in which the selection mark 25 is located.

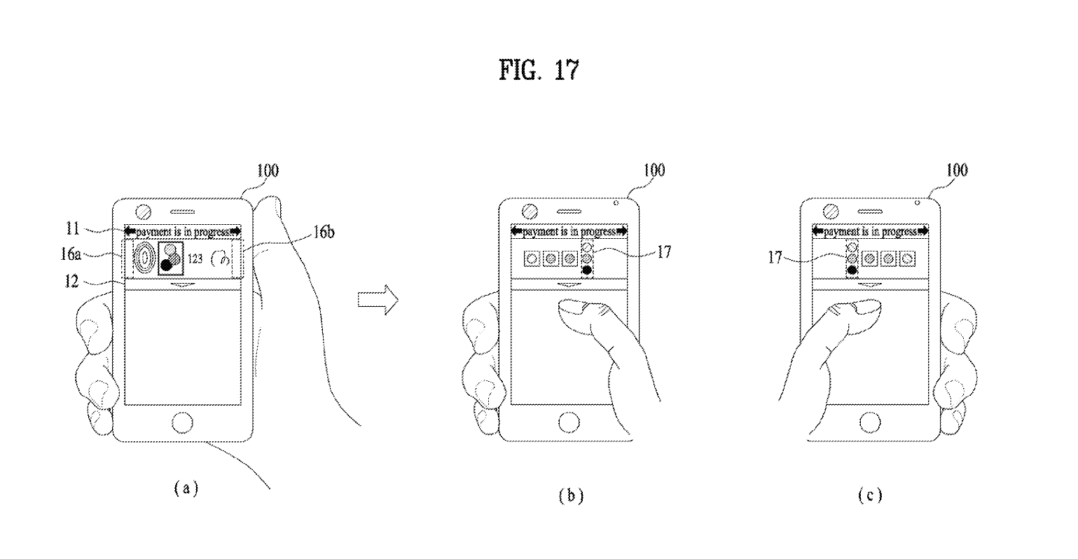

FIG. 17 is a view illustrating a terminal apparatus, in which a color pattern authentication system is selected, according to one embodiment of the present invention.

Referring to FIG. 17(a), a terminal apparatus 100 in which a color pattern authentication system is selected is shown. The terminal apparatus 100 may display various authentication systems between the notification window 11 and the guide 12 of the glance view area. The user may locate a selection mark in one authentication system and touch an empty space of a screen. The empty space of the screen may be a left area 16a or a right area 16b in which the authentication system is displayed. For example, if the user grips the terminal apparatus 100 with his/her left hand, the terminal apparatus 100 may recognize a touch of the left area 16a as a selection command. If the user grips the terminal apparatus 100 with his/her right hand, the terminal apparatus 100 may recognize a touch of the right area 16b as a selection command. If a color pattern authentication system is selected, the terminal apparatus 100 may execute the color pattern authentication system.

Referring to FIG. 17(b), a terminal apparatus 100 in which a color pattern authentication system according to one embodiment is executed is shown. Referring to FIG. 17(b), the user grips the terminal apparatus 100 with his/her right hand. Therefore, the user may freely use his/her right hand's thumb finger. The terminal apparatus 100 may sense the user's grip state. If it is determined that the user grips the terminal apparatus 100 with his/her right hand, the terminal apparatus 100 may display a color pattern FIG. 17 at a right portion of the glance view area. Since the detailed system has been described as above, its detailed description will be described.

Referring to FIG. 17(c), a terminal apparatus 100 in which a color pattern authentication system according to another embodiment is executed is shown. Referring to FIG. 17(c), the user grips the terminal apparatus 100 with his/her left hand. Therefore, the user may freely use his/her left hand's thumb finger. The terminal apparatus 100 may sense the user's grip state. If it is determined that the user grips the terminal apparatus 100 with his/her left hand, the terminal apparatus 100 may display the color pattern FIG. 17 at a left portion of the glance view area.

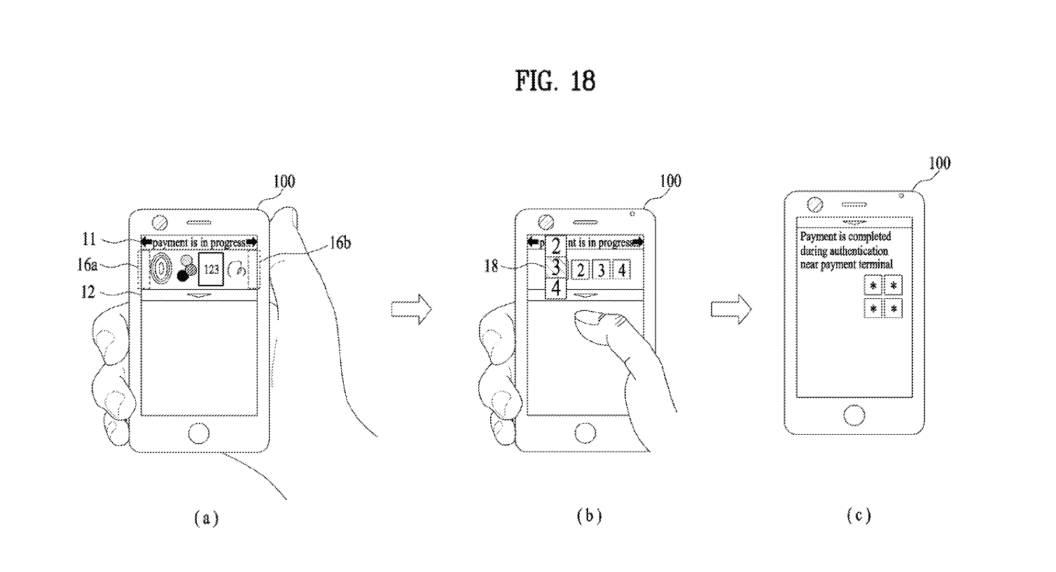

FIG. 18 is a view illustrating a terminal apparatus, in which a password authentication system is selected, according to one embodiment of the present invention.

Referring to FIG. 18(a), a terminal apparatus 100 in which a password authentication system is selected is shown. The terminal apparatus 100 may display various authentication systems between the notification window 11 and the guide 12 of the glance view area. The user may locate a selection mark in one authentication system and touch an empty space of a screen. If the user grips the terminal apparatus 100 with his/her left hand, the terminal apparatus 100 may recognize a touch of the left area 16a as a selection command. If the user grips the terminal apparatus 100 with his/her right hand, the terminal apparatus 100 may recognize a touch of the right area 16b as a selection command. The terminal apparatus 100 may select the password authentication system in accordance with the position of the selection mark and the input of the selection command.

Referring to FIG. 18(b), a terminal apparatus 100 which performs a password authentication procedure is shown. The terminal apparatus 100 may display a plurality of windows that may input a password. If the user selects one window, the terminal apparatus 100 may display a menu 18, which may input a number, on the selected window. The terminal apparatus 100 may input a number on the selected window on the basis of the user's swipe gesture and touch input. The terminal apparatus 100 may input the number selected by the user on the plurality of windows by repeating the aforementioned procedure.

Referring to FIG. 18(c), a terminal apparatus 100 in which an authentication procedure is completed is shown. The terminal apparatus 100 may determine whether an input number is matched with a preset password. If the input number is matched with the preset password, the terminal apparatus 100 may complete the authentication procedure.

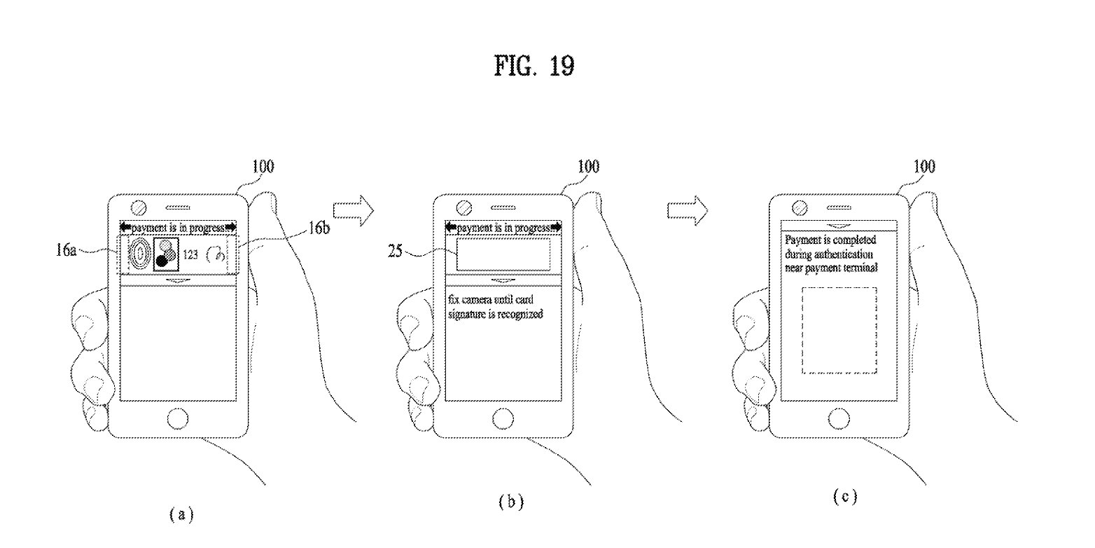

FIG. 19 is a view illustrating a terminal apparatus, in which a signature authentication system is selected, according to one embodiment of the present invention.

Referring to FIG. 19(a), a terminal apparatus 100 in which a signature authentication system is selected is shown. The terminal apparatus 100 may display various authentication systems between the notification window 11 and the guide 12 of the glance view area. The user may locate a selection mark in one authentication system and touch an empty space of a screen. If the user grips the terminal apparatus 100 with his/her left hand, the terminal apparatus 100 may recognize a touch of the left area 16a as a selection command. If the user grips the terminal apparatus 100 with his/her right hand, the terminal apparatus 100 may recognize a touch of the right area 16b as a selection command. The terminal apparatus 100 may select the signature authentication system in accordance with the position of the selection mark and the input of the selection command.

Referring to FIG. 19(b), a terminal apparatus 100 in which a signature pattern authentication system is selected is shown. The terminal apparatus 100 may display a signature input area 25 on a glance view area. The user may input a signature to the signature input area 25.

As the case may be, although the user has selected the signature authentication system, the terminal apparatus 100 may not include information on a preset signature. The terminal apparatus 100 may perform the authentication procedure by recognizing a signature written in a real card. If a signature authentication system is selected and there is no information on a preset signature, the terminal apparatus 100 may activate a camera function. The terminal apparatus 100 may display a message for requesting capturing of a signature. The terminal apparatus 199 may capture a signature of a real card and perform the authentication procedure.

Referring to FIG. 19(c), a terminal apparatus 100 in which an authentication procedure is completed is shown. The terminal apparatus 100 may complete the authentication procedure if a signature of a real card is capture and stored. The terminal apparatus 100 may analyze and store the capture signature information. The terminal apparatus 100 may use the stored signature information as signature information for signature authentication.

Meanwhile, the terminal apparatus 100 may return to a previous step in the middle of payment.

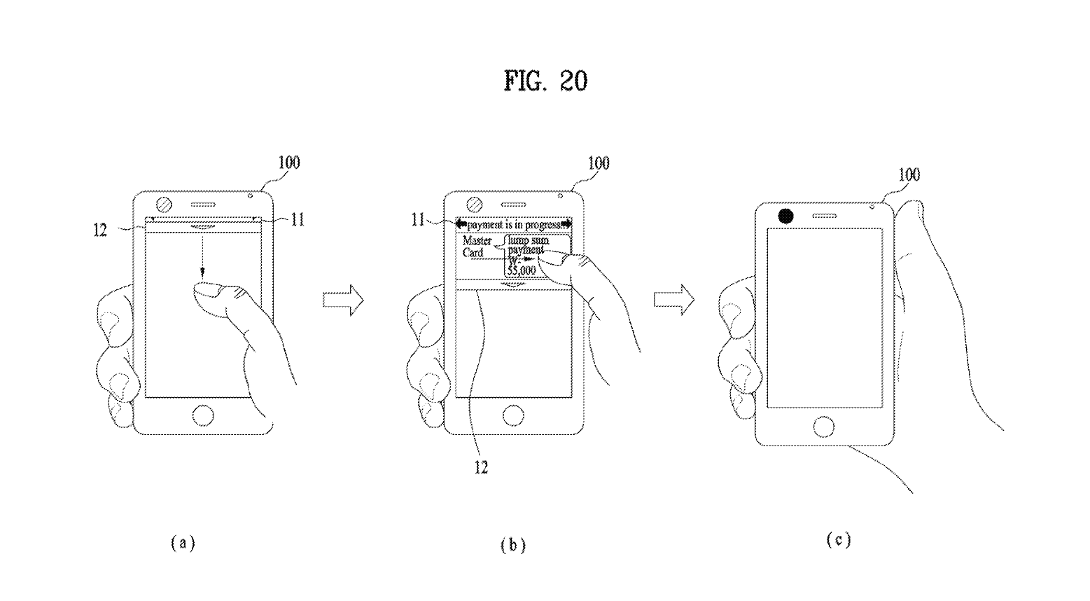

FIG. 20 is a view illustrating a method for switching to a previous step in accordance with one embodiment of the present invention.

Referring to FIG. 20(a), a terminal apparatus 100 for displaying a glance view is shown. The terminal apparatus 100 may display a glance view area in response to a user's swipe gesture. As an embodiment, the glance view area may include a notification window 11 and a guide 12. The terminal apparatus 100 may display a selection menu on an area between the notification window 11 and the guide 12.

Referring to FIG. 20(b), a terminal apparatus 100 in which a payment is in progress is shown. The terminal apparatus 100 may display a message indicating a current step on the notification window 11, and may display information related to the payment between the notification window 11 and the guide 12. The user may input a swipe gesture moving from the left side to the right side.

Referring to FIG. 20(c), a terminal apparatus 100 moved to the private payment starting step is shown. The terminal apparatus 100 may return to a previous step if the swipe gesture moving from the left side to the right side is input thereto. If the terminal apparatus included LED, the terminal apparatus 100 may change a color of the LED to a color corresponding to the previous step and display the changed color.

FIG. 21 is a view illustrating an example that a payment which is interrupted is completed.

Referring to FIG. 21(a), a terminal apparatus 100 which indicates payment interruption is shown. The payment procedure which is in progress may be interrupted. If the payment is interrupted, the terminal apparatus 100 may notify the user of the interrupted payment. For example, the terminal apparatus 100 may output a payment interruption message to the display unit. Otherwise, the terminal apparatus 100 may notify the user of the interrupted payment by changing a color using the LED and flickering the LED. Otherwise, the terminal apparatus 100 may notify the user of the interrupted payment by outputting a preset vibration or sound. The user may open a glance view by inputting the swipe gesture on the guide 12 of the glance view.

Referring to FIG. 21(b), a terminal apparatus 100 that has displayed a glance view is shown. The terminal apparatus 100 may display information related to the payment above the guide 12 of the glance view area. And, the terminal apparatus 100 may request authentication. Although the fingerprint authentication system is shown in FIG. 21(b), another authentication system may be used. The user may input a fingerprint to the terminal apparatus 100.

Referring to FIG. 21(c), a terminal apparatus 100 that has completed a payment is shown. The terminal apparatus 100 may analyze whether an input fingerprint is matched with a preset fingerprint. If the input fingerprint is matched with the preset fingerprint, the terminal apparatus 100 may complete authentication and complete the payment procedure if the terminal apparatus tags the payment terminal. If the user does not input a fingerprint for a preset time, the terminal apparatus 100 may end the payment procedure.

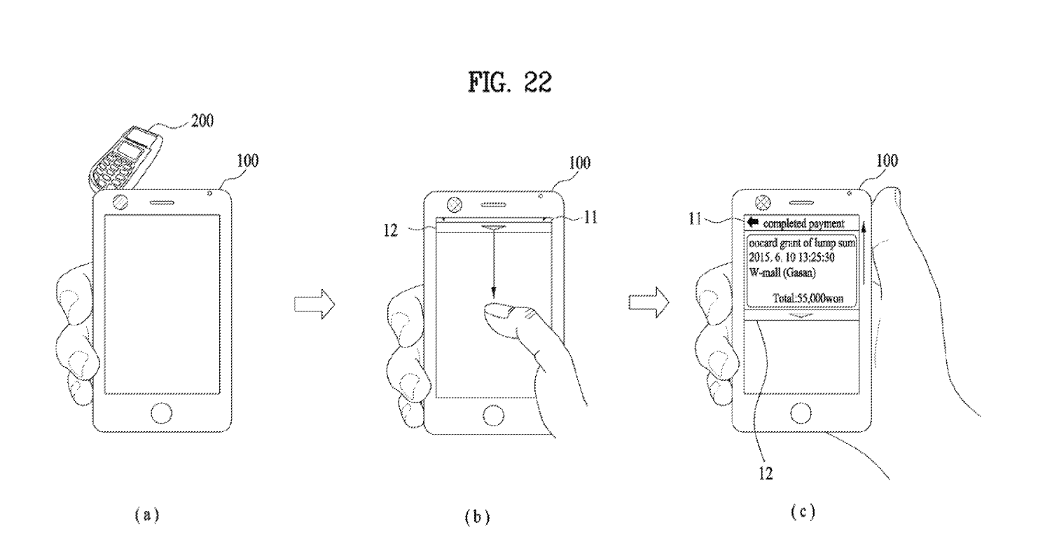

FIG. 22 is a view illustrating an example that paid information is displayed.

Referring to FIG. 22(a), a terminal apparatus 100 that tags the payment terminal is shown. The terminal apparatus 100 may perform a payment procedure in a private payment mode. The private payment mode is a mode that performs a payment without displaying personal information such as card information on a screen. However, for convenience of a user, the terminal apparatus 100 may display a simple message on a glance view area or a partial area of a screen. The terminal apparatus 100 may delete the displayed message if the user's operation or command based on the message is recognized. The terminal apparatus 100 may perform the authentication procedure and at the same time tag the payment terminal 200. Alternatively, after completing the authentication procedure, the terminal apparatus 100 may tag the payment terminal 200. If the terminal apparatus 100 tags the payment terminal 200, the payment procedure may be completed.

Referring to FIG. 22(b), a terminal apparatus 100 for displaying a glance view is shown. The user may input a swipe gesture on a screen. The terminal apparatus 100 may display a glance view area in accordance with the input swipe gesture. The glance view area may include a notification window 11 and a guide 12.

Referring to FIG. 22(c), a terminal apparatus 100 in which information on paid details is shown. The terminal apparatus 100 may display the information on paid details between the notification window 11 and the guide 12. The information on paid details may include a card which is used, a paid amount, time, and a used place. The terminal apparatus 100 may display a message indicating completed payment on the notification window.

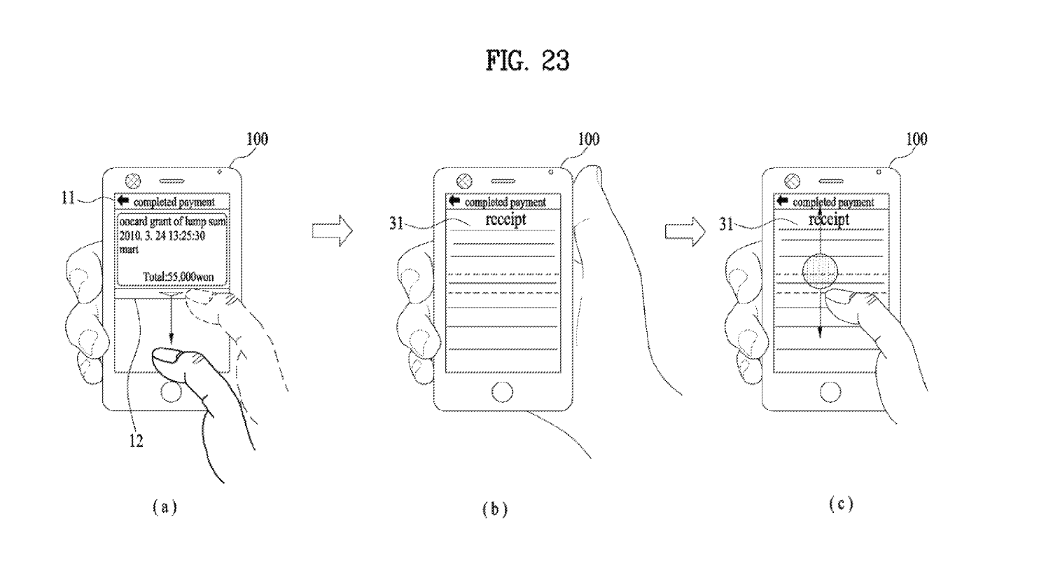

FIG. 23 is a view illustrating an example that a receipt is displayed.

Referring to FIG. 23(a), a terminal apparatus 100 in which summarized payment details are displayed is shown. The glance view area may include a notification window 11 and a guide 12. The terminal apparatus 100 may display the summarized payment details between the notification window 11 and the guide 12. The user may further scroll down the guide 12.

Referring to FIG. 23(b), a terminal apparatus 100 in which receipt information is displayed is shown. If the guide 12 is scrolled down below a preset threshold line, the summarized payment details may be switched to paid receipt information 31. For example, the threshold line may be a virtual lien of a middle area of a screen. Alternatively, the threshold line may be a virtual line of an end portion of a lower end of a screen.

Referring to FIG. 23(c), a terminal apparatus 100 for scrolling a receipt is shown. The terminal apparatus 100 may enlarge or downsize a receipt in accordance with a touch command of the user. Alternatively, the receipt information 31 may not be included in a full screen. The user may input a swipe gesture moving to an up or down direction. As described above, the swipe gesture may include a drag gesture, a flicking gesture, or a scroll gesture. The terminal apparatus 100 may move the receipt information 31, which is displayed based on the user's gesture which is input, to an up or down direction.

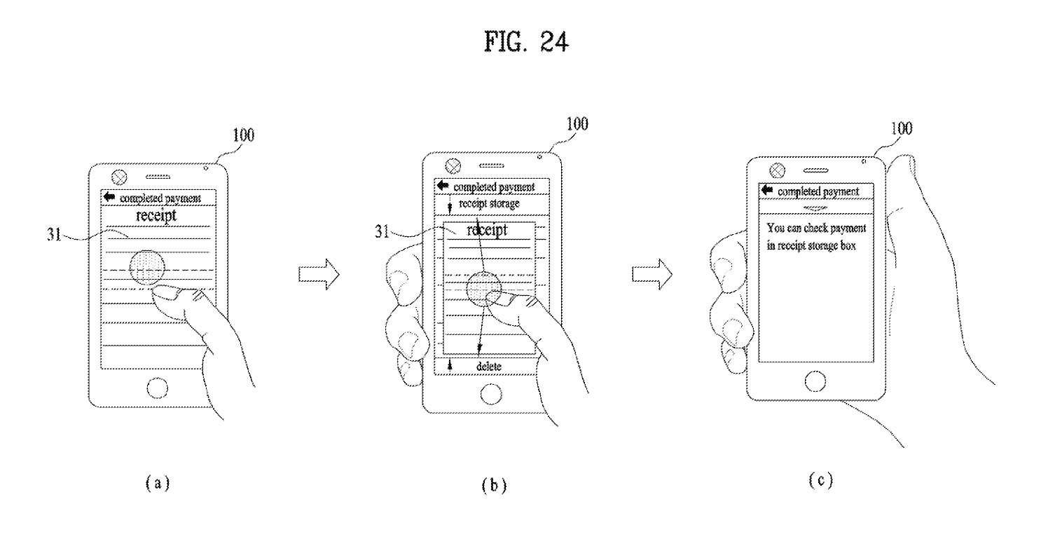

FIG. 24 is a view illustrating an example that a receipt is kept.

Referring to FIG. 24(a), a terminal apparatus 100 for displaying receipt information 31 is shown. The terminal apparatus 100 may display a receipt management menu if a touch is input on the displayed receipt information 31 for a preset time or more. The terminal apparatus 100 may receive the receipt information and store the received receipt information in a temporary storage box if the payment is completed. The terminal apparatus 100 may store or delete the receipt stored in the temporary storage box in or from the receipt storage box in accordance with the user's selection.

Referring to FIG. 24(b), a terminal apparatus 100 in which a receipt management menu is displayed is shown. If the receipt information 31 is touched for a preset time or more, the terminal apparatus 100 may display the receipt management menu. The receipt management menu may include a moving item to a storage box or a delete item. When the receipt management menu is displayed, the terminal apparatus 100 may reduce a size of the receipt information 31 to conveniently move the receipt information 31. As an embodiment, the moving item to the storage box may be displayed on an upper end of a screen, and the delete item may be displayed on a lower end of the screen. The user may move the receipt information 31 touched by the item on the upper end or the lower end while maintaining the touch. If the user moves the receipt information 31 to the moving item to the storage box on the upper end, the terminal apparatus 100 may store the receipt information 31 in the receipt storage box. If the user moves the receipt information 31 to the delete item on the lower end, the terminal apparatus 100 may delete the receipt information 31. In FIG. 24(b), the user may move the receipt information 31 to the moving item to the storage box.

Referring to FIG. 24(c), a terminal apparatus 100 in which receipt information is kept is shown. The terminal apparatus 100 may store the receipt information 31 in the receipt storage box if the receipt information is kept and output a notification message to the user.

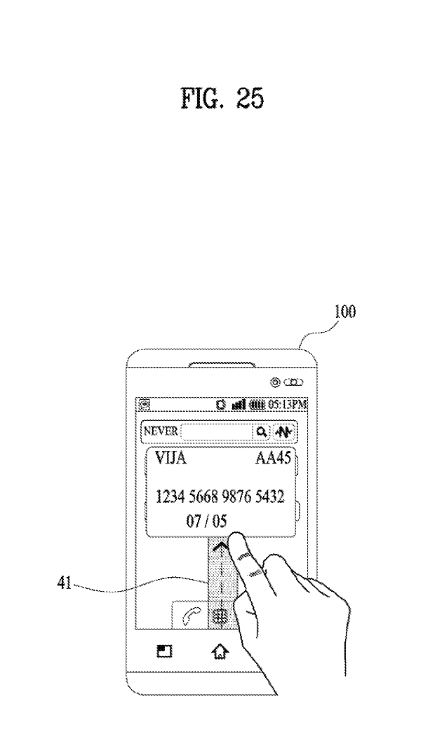

FIG. 25 is a view illustrating an example that paid details are displayed.

Referring to FIG. 25, a terminal apparatus 100 is shown. If a payment is completed, the terminal apparatus 100 may return to a home screen. Alternatively, the terminal apparatus 100 may execute other application. The user may input a swipe gesture on a center area 41 of a screen. The center area 41 of the screen may mean an area that includes a preset area at a center point of the screen on the basis of a left and right direction.

The terminal apparatus 100 may display a set card on the basis of the input swipe gesture. If the swipe gesture in the left and right direction is input on the displayed card, the terminal apparatus 100 may switch the set card to another card which is set. The user may input a touch gesture that means an enlargement command in the displayed card.

The terminal apparatus 100 may display receipt information paid by the displayed card in response to the input touch gesture. Otherwise, the terminal apparatus 100 may display all kinds of receipt information if the touch gesture that means an enlargement command is input in a state that the card is displayed. Otherwise, the terminal apparatus 100 may display only receipt information stored in the temporary storage box.

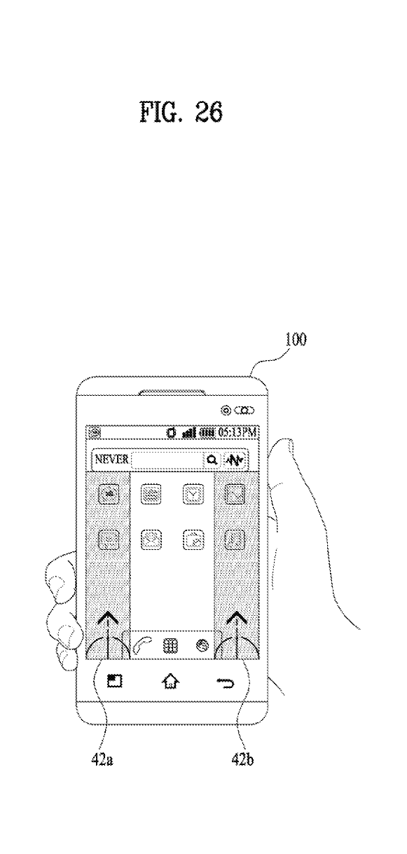

FIG. 26 is a view illustrating another example that paid details are displayed.

Referring to FIG. 26, a terminal apparatus 100 is shown. The user may input a swipe gesture from a left area 42a or a right area 42b of a screen. The terminal apparatus 100 may display a screen of paid details if the swipe gesture is input from the left area 42a or the right area 42b of the screen.

The left area 42a or the right area 42b of the screen may be an area allocated from an end of the screen at a preset width. The left area 42a or the right area 42b of the screen may be set in the terminal apparatus 100 and may not be displayed to the outside.

The user may grip the terminal apparatus 100 with one hand. If the user grips the terminal apparatus 100 with a left hand, the user may input a swipe gesture on the left area 42a of the screen with a left hand's thumb finger. The terminal apparatus 100 may sense the grip state of the user. If it is determined that the user grips the terminal apparatus 100 with a left hand, the terminal apparatus 100 may set the left area 42a of the screen to a payment details screen switching area. If the user grips the terminal apparatus 100 with a right hand, the user may input a swipe gesture on the right area 42b of the screen with a right hand's thumb finger. The terminal apparatus 100 may sense the grip state of the user. If it is determined that the user grips the terminal apparatus 100 with a right hand, the terminal apparatus 100 may set the right area 42b of the screen to a payment details screen switching area.

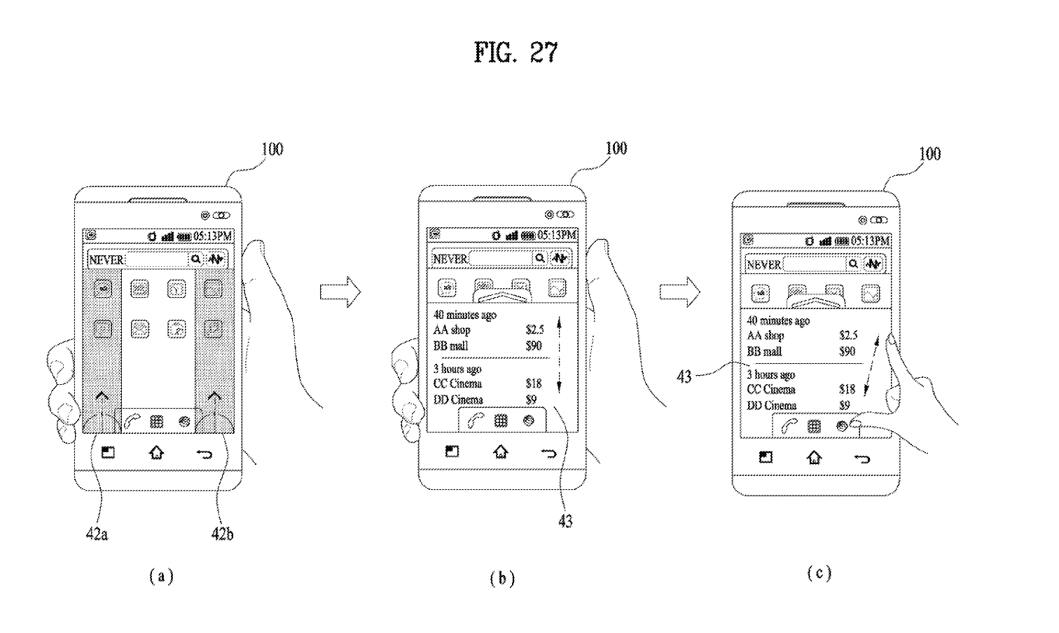

FIG. 27 is a view illustrating an example that is switched to a payment details screen.

Referring to FIG. 27(a), a terminal apparatus 100 to which a swipe gesture is input on the left area 42a or the right area 42b of the screen is shown. As described above, the terminal apparatus 100 may receive the swipe gesture on the left area 42a or the right area 42b of the screen in accordance with the grip state of the user. The terminal apparatus 100 may display a payment details screen if the swipe gesture is input thereto.

Referring to FIG. 27(b), a terminal apparatus 100 that has displayed a payment details screen 43 is displayed is shown. The payment details screen 43 is a screen that displays summarized payment information. The payment details screen 43 may display details stored in the receipt temporary storage box. Alternatively, the payment details screen 43 may display full payment details. The payment details screen 43 may be displayed in the reverse order of paid time. The terminal apparatus 100 may scroll the payment details screen 43 up and down in response to the swipe gesture input on the payment details screen 43.

Referring to FIG. 27(c), a terminal apparatus 100 in which the payment details screen 43 is enlarged is shown. The user may input a gesture for enlarging the screen on the payment details screen 43. The terminal apparatus 100 may switch the current screen to a screen related to a receipt in response to the input gesture. For example, the terminal apparatus 100 may switch the current screen to a temporary storage screen of the receipt. Alternatively, the terminal apparatus 100 may switch the current screen to a screen for displaying receipt information related to details displayed on the current screen.

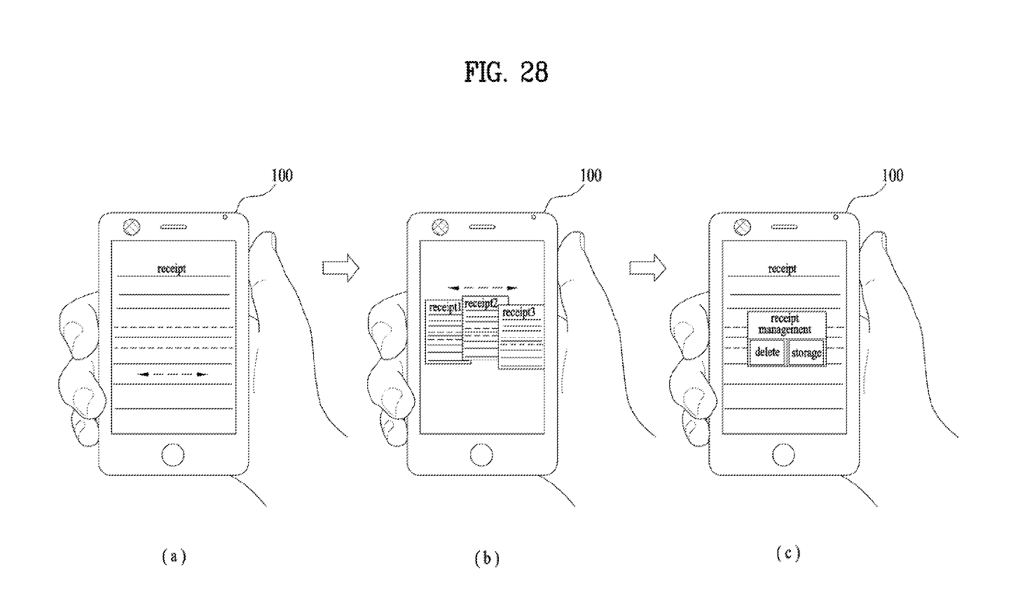

FIG. 28 is a view illustrating an example that a receipt is switched to a receipt storage box.

Referring to FIG. 28(a), a terminal apparatus 100 that has displayed receipt information is shown. If an enlargement gesture is input on the payment details screen, the terminal apparatus 100 may switch the current screen to the temporary storage screen of the receipt or the screen for displaying receipt information related to the displayed payment details. The terminal apparatus 100 may display receipt information temporarily stored in the temporary storage box of the receipt. Alternatively, the terminal apparatus 100 may display receipt information related to the displayed payment details. The receipt information may be displayed on a full screen, or may be switched to previous or next receipt information in accordance with the input of the swipe gesture. Also, the terminal apparatus 100 may include a full receipt display button. If the full receipt display button is selected, the terminal apparatus 100 may display a plurality of kinds of receipt information on one screen.

Referring to FIG. 28(b), a terminal apparatus 100 that has displayed a plurality of kinds of receipt information on one screen is shown. The terminal apparatus 100 may display the plurality of kinds of receipt information on one screen in accordance with the selection of the full receipt display button. If the swipe gesture is input, the terminal apparatus 10 may upwardly display a plurality of kinds of receipts which are overlapped, in due order.

Referring to FIG. 28(c), a terminal apparatus 100 that stores receipts in a receipt storage box is shown. The user may select receipt information displayed on the top. The terminal apparatus 100 may display the selected receipt information on a full screen. The user may input a touch of a preset time or more on the receipt information displayed on the full screen. If a long touch gesture is input, the terminal apparatus 100 may display a menu for managing the displayed receipt information. For example, the menu may include a delete button or a storage button. If the delete button is selected, the terminal apparatus 100 may delete the displayed receipt information. If the storage button is selected, the terminal apparatus 100 may store the displayed receipt information in the receipt storage box.

The terminal apparatus 100 may switch the home screen to the receipt storage box or the temporary storage box.

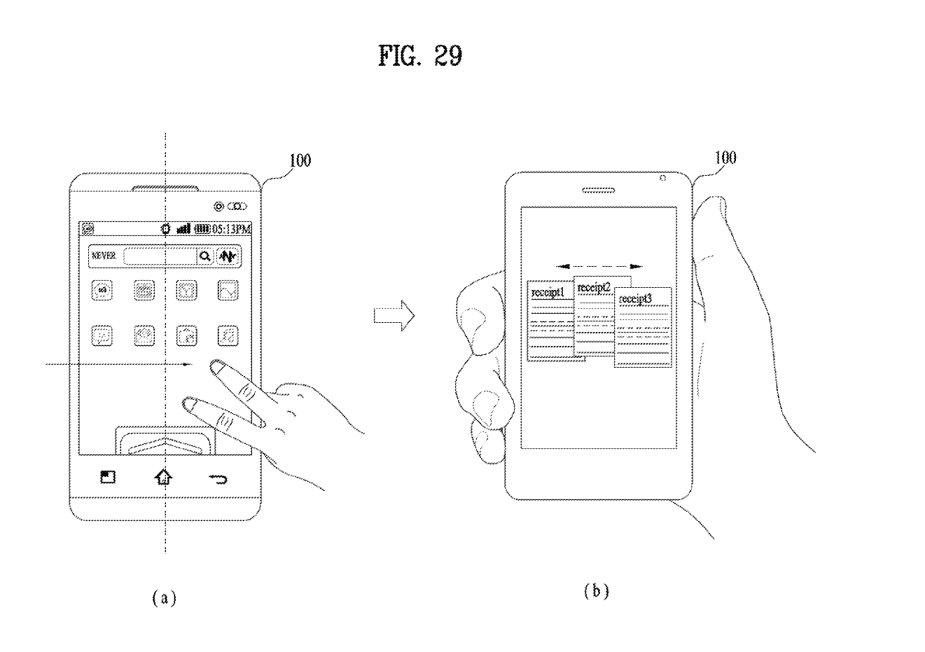

FIG. 29 is a view illustrating another example that is switched to a receipt temporary storage screen.

Referring to FIG. 29(a), a terminal apparatus 100 that displays a home screen is shown. The home screen is an example, and the terminal apparatus 100 may display another screen. In other words, the terminal apparatus 100 may end the normal payment mode or the private payment mode and display another screen. The terminal apparatus 100 may receive a preset gesture moving from a first side corner of the screen to an opposite side corner. For example, the terminal apparatus 100 may receive a 2-finger swipe gesture moving from a left corner of the screen to a right corner thereof.

Referring to FIG. 29(b), a terminal apparatus 100 that displays a receipt temporary storage screen is shown. If the aforementioned 2-finger swipe gesture satisfies a preset condition, the terminal apparatus 100 may switch the current screen to the receipt temporary storage screen. For example, if the 2-finger swipe gesture moves at a preset width or more, the terminal apparatus 100 may switch the current screen to the receipt temporary storage screen. As a detailed example, if the 2-finger swipe gesture moves at 3 cm or more, the terminal apparatus 100 may switch the current screen to the receipt temporary storage screen.

Alternatively, if the 2-finger swipe gesture exceeds a preset line, the terminal apparatus 100 may switch the current screen to the receipt temporary storage screen. As a detailed example, if the 2-finger swipe gesture moves from a left area of the screen to a right area beyond a center line of the screen, the terminal apparatus 100 may switch the current screen to the receipt temporary storage screen.

The receipt temporary storage screen may include a plurality of receipts. The terminal apparatus 100 may upwardly display the plurality of kinds of receipt information in due order on the basis of the swipe gesture input on the receipt temporary storage screen.

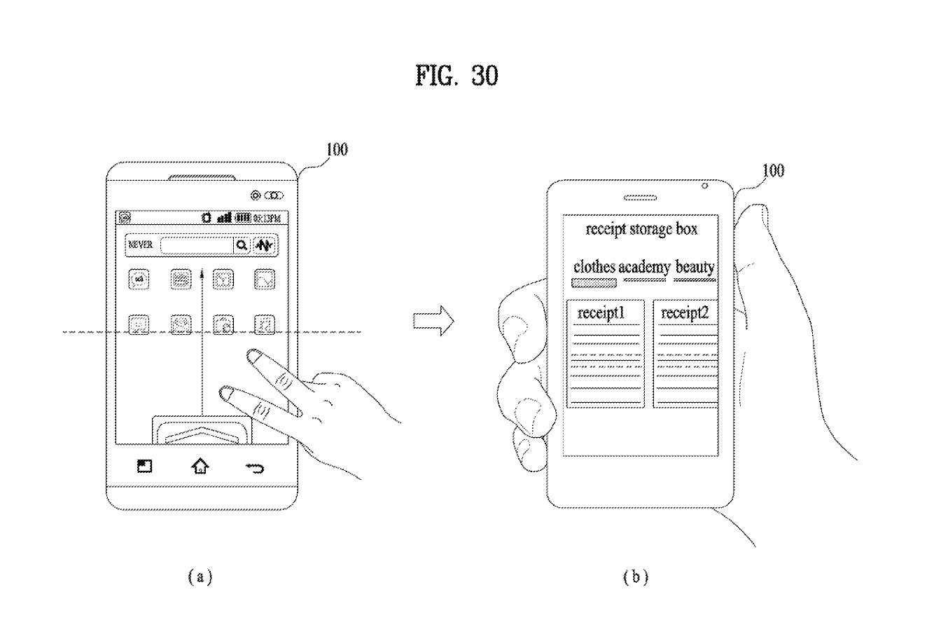

FIG. 30 is a view illustrating an example that is switched to a receipt storage screen.

Referring to FIG. 30(a), a terminal apparatus 100 that displays a home screen is shown. The home screen is an example, and the terminal apparatus 100 may display another screen. In other words, the terminal apparatus 100 may end the normal payment mode or the private payment mode and display another screen. The terminal apparatus 100 may receive a preset gesture moving from a first side corner of the screen to an opposite side corner. For example, the terminal apparatus 100 may receive a 2-finger swipe gesture moving from a lower end corner of the screen to an upper end corner thereof.

Referring to FIG. 30(b), a terminal apparatus 100 that displays a receipt storage box is shown. If the aforementioned 2-finger swipe gesture satisfies a preset condition, the terminal apparatus 100 may switch the current screen to the receipt storage screen. For example, if the 2-finger swipe gesture moves at a preset width or more, the terminal apparatus 100 may switch the current screen to the receipt storage screen. As a detailed example, if the 2-finger swipe gesture moves at 3 cm or more, the terminal apparatus 100 may switch the current screen to the receipt storage screen.

Alternatively, if the 2-finger swipe gesture exceeds a preset line, the terminal apparatus 100 may switch the current screen to the receipt storage screen. As a detailed example, if the 2-finger swipe gesture moves from a lower end area of the screen to an upper end area beyond a center line of the screen, the terminal apparatus 100 may switch the current screen to the receipt storage screen.

The receipt storage screen may include a plurality of categories. The terminal apparatus 100 may classify information on each receipt per category on the basis of the receipt information. The terminal apparatus 100 may classify the receipt information within the same category in the order of recent date.

Meanwhile, the terminal apparatus 100 may display the payment procedure by using a figure.

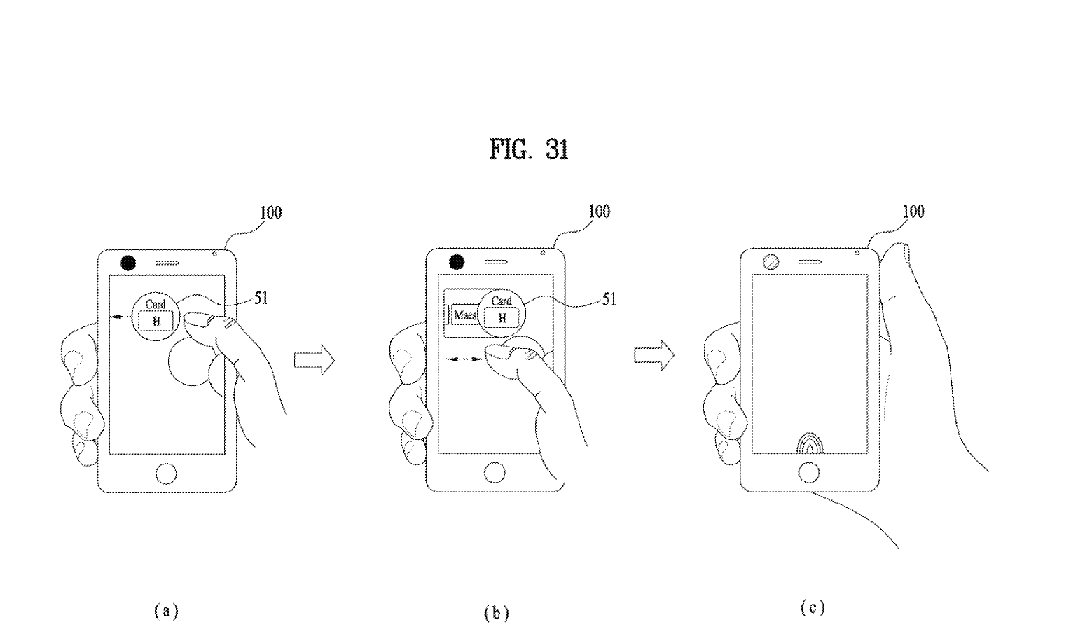

FIG. 31 is a view illustrating an example that a card payment is selected.

Referring to FIG. 31(a), a terminal apparatus 100 that displays a card determining step is shown. If the private payment mode is executed, the terminal apparatus 100 may display a plurality of figures. The plurality of figures may be displayed on a right area or a left area of the screen in accordance with the grip state of the user. For example, if the user grips the terminal apparatus 100 with a left hand, the terminal apparatus 100 may sense the grip state and display the plurality of figures on the left area of the screen. If the user grips the terminal apparatus 100 with a right hand, the terminal apparatus 100 may sense the grip state and display the plurality of figures on the right area of the screen.

The terminal apparatus 100 may display card information preset from a first figure 51. The user may input a swipe gesture moving to the left or right side on the first figure 51 of the plurality of figures. If the user grips the terminal apparatus 100 with a left hand, the terminal apparatus 100 may receive the swipe gesture moving from the left side to the right side. Alternatively, if the user grips the terminal apparatus 100 with a right hand, the terminal apparatus 100 may receive the swipe gesture moving from the right side to the left side. The embodiment in which the terminal apparatus 100 is gripped by the right hand of the user will be described below.

Referring to FIG. 31(b), a terminal apparatus 100 that displays a plurality of cards is shown. The terminal apparatus 100 may display a menu, which may select a card, at a side of the first figure 51 on the basis of the swipe gesture. That is, the terminal apparatus 100 may display a plurality of stored cards. The user may input a swipe gesture when a menu, which may select a card, is displayed. The terminal apparatus 100 may sequentially move the plurality of cards in response to the input swipe gesture. The terminal apparatus 100 may sequentially change the card information displayed on the initial figure on the basis of the swipe gesture. If the user inputs a touch, the terminal apparatus 100 may set the card displayed on the first figure 51 to a card for payment.

Referring to FIG. 31(c), a terminal apparatus 100 that performs an authentication procedure is shown. Although a fingerprint authentication system is shown in FIG. 31(c), another authentication system may be performed. The terminal apparatus 100 may perform the authentication procedure and then perform the payment procedure if the terminal apparatus accesses the payment terminal.

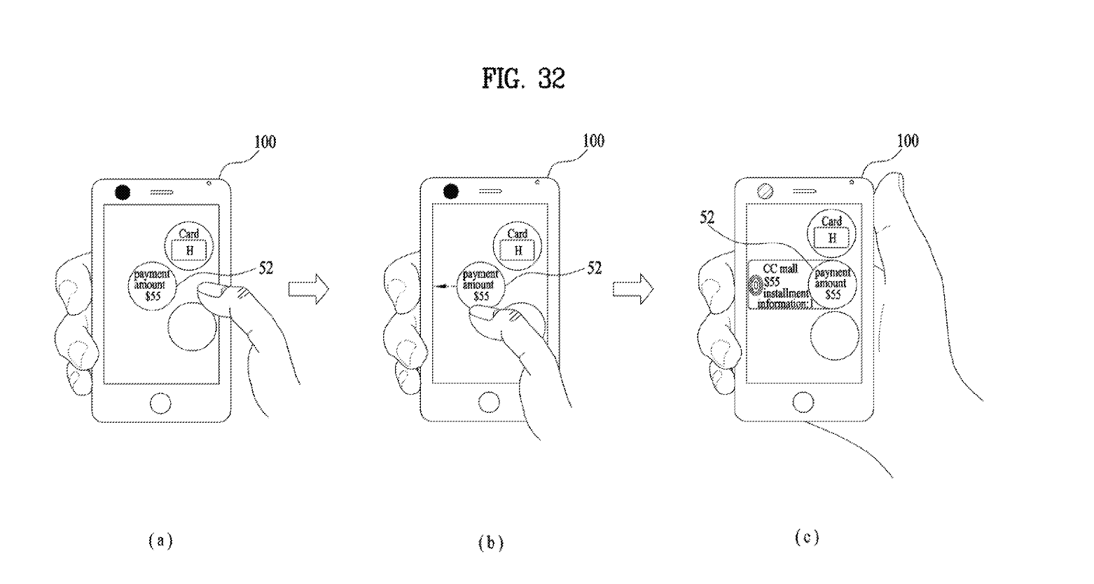

FIG. 32 is a view illustrating an example that information to be paid is displayed.

Referring to FIG. 32(a), a terminal apparatus 100 that displays an estimated payment amount is shown. The terminal apparatus 100 may access the payment terminal without performing the authentication procedure. If the terminal apparatus 100 accesses the payment terminal without performing the authentication procedure, the terminal apparatus 100 may receive information such as an estimated payment amount. The terminal apparatus 100 may display the received information on a second figure 52 of the plurality of figures. Meanwhile, if the terminal apparatus ends a card selection procedure, the terminal apparatus 100 may upward move the first figure and move the second figure 52 to the position where the first figure has been located.

Referring to FIG. 32(b), a terminal apparatus 100 to that a swipe gesture is input is shown. The user may input a swipe gesture moving to a left side on the second figure 52.

Referring to FIG. 32(c), a terminal apparatus 100 that displays received summarized information is shown. The terminal apparatus 100 may display information related to payment on a side of the second figure 52 on the basis of the swipe gesture. For example, the information related to payment may include an estimated payment amount, a payment place, installment information or information on an authentication system.

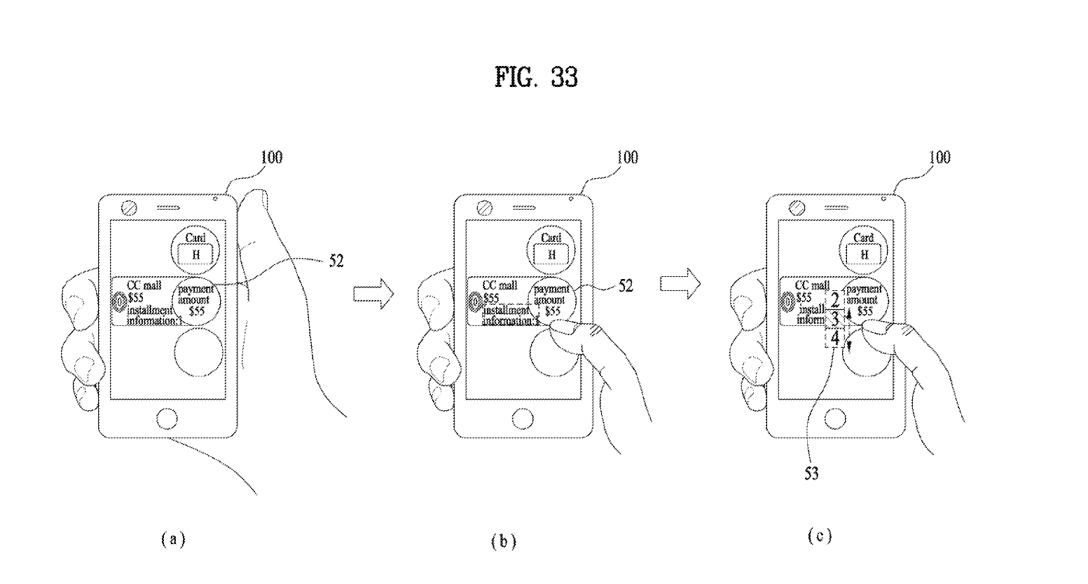

FIG. 33 is a view illustrating an example that an installment payment is selected.

Referring to FIG. 33(a), a terminal apparatus 100 that displays received summarized information is shown. The terminal apparatus 100 may display an estimated payment amount, a payment place, installment information or information on an authentication system on the side of the second figure 52.

Referring to FIG. 33(b), a terminal apparatus 100 that changes installment information is shown. The user may touch an area on which the installment information is displayed, for a preset time or more.

Referring to FIG. 33(c), a terminal apparatus 100 that changes an installment month is shown. The terminal apparatus 100 may display a menu 53, which may select an installment month, if a long touch gesture is input thereto. When the menu 53 which may select an installment month is displayed, the user may input a swipe gesture moving to a direction parallel with a number arrangement direction. The terminal apparatus 100 may move the number in accordance with the input swipe gesture. The menu 53 which may select an installment month may include a plurality of areas on which numbers are displayed. Also, the menu 53 which may select an installment month may include one area that may be identified from the other areas. If a selection command of the user is input, the number displayed on one area identified from the other areas may be a selected installment month. As a detailed example, referring to FIG. 33(c), the menu 53 which may select an installment month include areas on which 2, 3 and 4 are displayed. The area on which 3 is displayed may be identified from the areas on which the other numbers are displayed. The user may select a number by touching a random area on the screen. That is, the terminal apparatus 100 may select 3 and determine 3-month installment if a selection command is input in a state displayed as shown in FIG. 33(c).

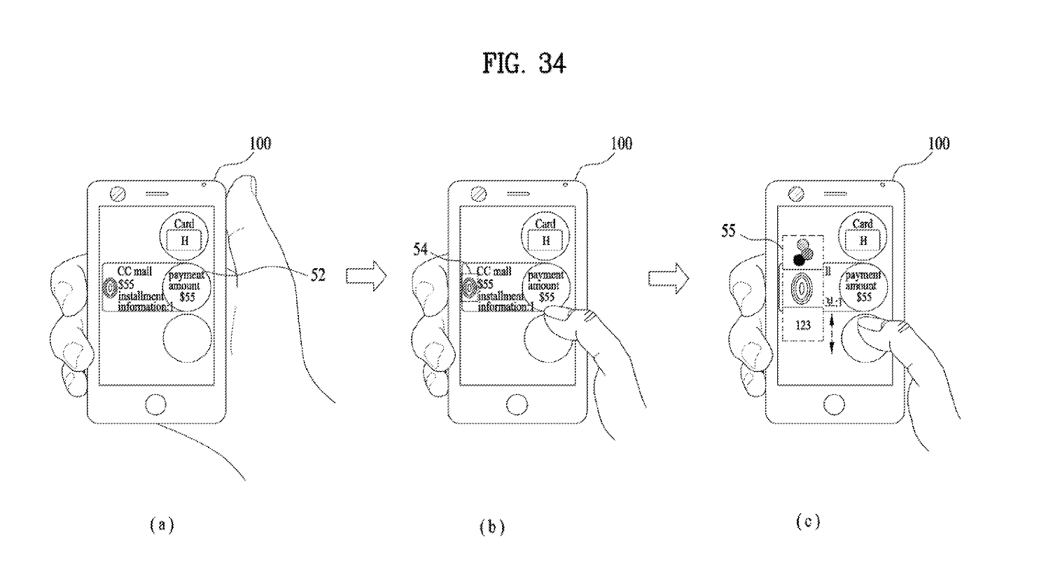

FIG. 34 is a view illustrating an example that an authentication system is selected.

Referring to FIG. 34(a), a terminal apparatus 100 that displays received summarized information is shown. The terminal apparatus 100 may display an estimated payment amount, a payment place, installment information or information on an authentication system on the side of the second figure 52.

Referring to FIG. 34(b), a terminal apparatus 100 that selects an authentication system is shown. The user may touch an area 54 on which the authentication system is displayed, for a preset time or more.

Referring to FIG. 34(c), a terminal apparatus 100 that changes an authentication system is shown. The terminal apparatus 100 may display a menu 55, which may select an authentication system, if a long touch gesture is input thereto. When the menu 55 which may select an authentication system is displayed, the user may input a swipe gesture moving to a direction parallel with an authentication system arrangement direction. The terminal apparatus 100 may move the authentication system in accordance with the input swipe gesture. The menu 55 which may select an authentication system may include a plurality of areas on which authentication systems are displayed. Also, the menu 55 which may select an authentication system may include one area that may be identified from the other areas. If a selection command of the user is input, the authentication system displayed on one area identified from the other areas may be a selected authentication system.

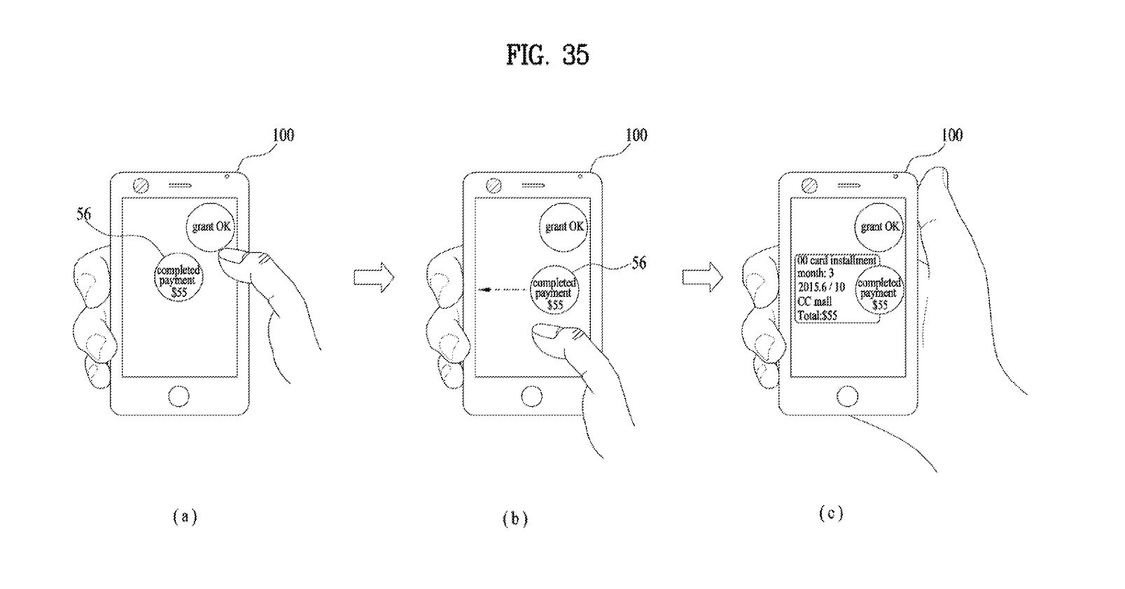

FIG. 35 is a view illustrating an example that details which are paid are displayed.

Referring to FIG. 35(a), a terminal apparatus 100 that displays a completed payment message is shown. The terminal apparatus 100 may display the completed payment message on a third figure 56. The completed payment message may include a payment amount. Meanwhile, if the payment is completed, the terminal apparatus 100 may upwardly move the second figure and move the third figure 56 to the position where the second figure has been located.

Referring to FIG. 35(b), a terminal apparatus 100 to which a swipe gesture is input is shown. The user may input a swipe gesture moving to a left side on the third figure 56.

Referring to FIG. 35(c), a terminal apparatus 100 that displays summarized payment information is shown. The terminal apparatus 100 may display summarized payment information on the basis of the swipe gesture. For example, the summarized payment information may include a card which is used, an installment month, payment date, a payment place and a payment amount. Meanwhile, the respective figures may be displayed at their respective colors different from each other.

The various embodiments of the terminal apparatus 100 have been described as above. A flow chart of a control method for a terminal apparatus will be described below.

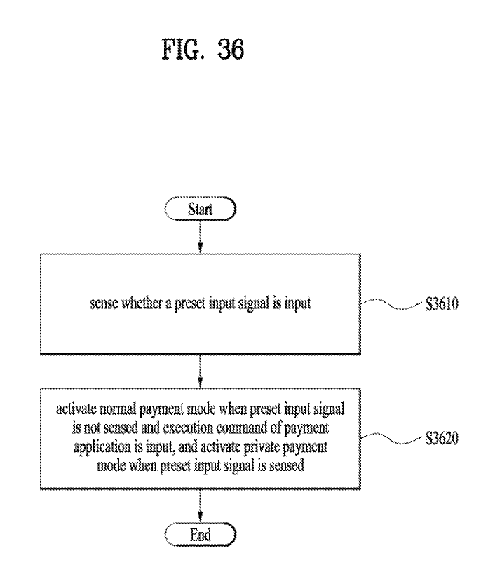

FIG. 36 is a flow chart illustrating a control method of a terminal apparatus according to one embodiment of the present invention.

The terminal apparatus may sense whether a preset input signal is input (S3610).

The terminal apparatus may activate the normal payment mode if the preset input signal is not sensed and an execution command of a payment application is input thereto. The terminal apparatus may activate the private payment mode if the preset input signal is sensed (S3620). The private payment mode is a mode that does not display data such as card information on the screen. The preset input signal may include a vibration gesture input signal related to vibration of the terminal apparatus, a fingerprint input signal, a touch input signal for a preset area, or a swipe touch input signal for enlarging a glance view.

Meanwhile, the terminal apparatus may receive a swipe gesture moving to a first direction on a preset area of the display unit after the private payment mode is activated. If the swipe gesture is input to the terminal apparatus, the terminal apparatus may display a glance view area indicating a private payment state. If the touch of the swipe gesture ends, the glance view area may disappear.

The private payment mode may include a plurality of steps. The terminal apparatus may change a color of LED or change a vibration pattern or sound and then output the changed result if one step ends and then moves to next step.

The above-described present invention may be implemented in a medium in which a program is recorded, as a code that can be read by a computer. Example of the medium that can be read by a computer include an HDD (hard disk drive), an SSD (solid state disk), an SDD (silicon disk drive), a ROM, a RAM, a CD-ROM, a magnetic tape, a floppy disk, and an optical data storage unit. Also, another example of the recording medium may be implemented in a type of carrier wave (for example, transmission through Internet). Also, the computer may include the controller 180 of the terminal apparatus. Thus, the above detailed description is to be considered in all respects as illustrative and not restrictive. The scope of the present invention should be determined by reasonable interpretation of the appended claims and all changes which come within the equivalent scope of the invention are included in the scope of the invention.

### Mode for Carrying out the Invention

z,999

1. A terminal apparatus comprising:
a sensing unit sensing a preset input signal;
a display unit displaying content and receiving a touch gesture input; and
a controller activating a normal payment mode when the preset input signal is not sensed and an execution command of a payment application is input and activating a private payment mode when the preset input signal is sensed.

2. The terminal apparatus according to claim 1, wherein the preset input signal comprises at least a vibration gesture related to vibration of the terminal apparatus, a fingerprint input, or a touch input to a preset area.

3. The terminal apparatus according to claim 1, wherein the controller controls the display unit to display a glance view area indicating the private payment mode when a swipe gesture in a first direction is input on a preset area of the display unit after the private payment mode is activated.

4. The terminal apparatus according to claim 3, wherein the controller controls the display unit to no longer display the glance view area when the swipe gesture is no longer input.

5. The terminal apparatus according to claim 3, wherein the controller controls the display unit to maintain the glance view area when the swipe gesture is no longer input after the swipe gesture is switched to a second direction.

6. The terminal apparatus according to claim 3, wherein the controller controls the display unit to display at least one card on the glance view area when the private payment mode corresponds to a payment step.

7. The terminal apparatus according to claim 3, wherein the controller controls the display unit to display at least one authentication system on the glance view area when the private payment mode corresponds to an authentication step.

8. The terminal apparatus according to claim 7, wherein the at least one authentication system comprises at least a fingerprint authentication system, a color pattern authentication system, a password authentication system, or a signature authentication system.

9. The terminal apparatus according to claim 1, further comprising an output unit outputting a signal when the activated private payment mode is changed.

10. The terminal apparatus according to claim 9, wherein the output unit includes at least a light emitting diode (LED) or a vibration motor.

11. The terminal apparatus according to claim 1, wherein the controller controls the display unit to display a preset card when a swipe gesture in a specific direction from a center area of a lower corner of the display unit is input after the activated normal payment mode or private payment mode ends.

12. The terminal apparatus according to claim 11, wherein the controller controls the display unit to display a receipt storage screen related to a card when a gesture for enlarging a screen is input after the card is displayed.

13. The terminal apparatus according to claim 1, wherein the controller controls the display unit to display paid details when a swipe gesture is input from both side areas of a lower corner of the display unit in a specific direction after the activated normal payment mode or private payment mode ends.

14. The terminal apparatus according to claim 13, wherein:
the preset input signal comprises a grip state of a user;
the controller controls the display unit to display the paid details based of the swipe gesture from a left area of the lower corner of the display unit in the specific direction when it is determined that the grip state indicates that the user grips the terminal apparatus with a left hand; and
the controller controls the display unit to display the paid details based on the swipe gesture from a right area of the lower corner of the display unit in the specific direction when it is determined that the grip state indicates that the user grips the terminal apparatus with a right hand.

15. The terminal apparatus according to claim 1, wherein the controller controls the display unit to display a receipt temporary storage screen when a two-finger swipe gesture is input from a preset side corner of the display unit to an opposite side corner of the display unit after the activated normal payment mode or private payment mode ends.

16. The terminal apparatus according to claim 1, wherein the controller controls the display unit to display a receipt storage screen when a two-finger swipe gesture is input from a preset side corner of the display unit to an opposite side corner of the display unit after the activated normal payment mode or private payment mode ends.

17. The terminal apparatus according to claim 2, wherein the controller controls the display unit to display a color figure indicating a first step as a first background color within a preset range from a touched point when the touch input to the preset area is sensed.

18. The terminal apparatus according to claim 17, wherein the controller controls the display unit to display a selection menu when a swipe gesture is input from the displayed color figure in a predetermined direction.

19. The terminal apparatus according to claim 17, wherein the controller controls the display unit to end a current step and switch to a color figure indicating a second step as a second background color when a touch gesture to the displayed color figure is input.

20. A control method for a terminal apparatus, the method comprising:
sensing whether a preset input signal is input; and
activating a normal payment mode when the preset input signal is not sensed and an execution command of a payment application is input; and
activating a private payment mode when the preset input signal is sensed.
